(19) United States
(12) Patent Application Publication
(10) Pub. No.: US 2023/0297748 A1
(43) Pub. Date: Sep. 21, 2023

(54) HIERARCHICAL FLOOR-PLANNING FOR RAPID FPGA PROTOTYPING

(71) Applicant: University of Utah Research Foundation, Salt Lake city, UT (US)

(72) Inventors: Ganesh Gore, Salt Lake City, UT (US); Xifan Tang, Salt Lake City, UT (US); Pierre-Emmanuel Gaillardon, Salt Lake City, UT (US)

(21) Appl. No.: 17/695,093

(22) Filed: Mar. 15, 2022

(51) Int. Cl. G06F 30/347

(52) U.S. Cl. CPC G06F 30/347; G06F 2119/12

(57) ABSTRACT

Technology is disclosed related to methods and devices for reducing the top-level placement and routing runtime of a field-programmable gate arrays (FPGA). The method can comprise: generating a global signal netlist comprising feedthrough connections through non-adjacent FPGA modules; selecting a predefined signal connection pattern for the global signal netlist; generating pre-routed feedthrough connections based on the predefined signal connection pattern and the global signal netlist; and generating a pre-routed global signal netlist from the pre-routed feedthrough connections. The FPGA can comprise an FPGA module configured to send a pre-routed global signal to a non-adjacent FPGA module through a pre-routed feedthrough connection identified using a predefined signal connection pattern.

### GOVERNMENT INTEREST

This invention was made with government support under grant FA8650-18-2-7855 awarded by the Department of Defense/DARPA. The government has certain rights in the invention.

### FIELD OF THE DISCLOSURE

The present disclosure relates to electronic devices, field programmable gate arrays (FPGA) design, reconfigurable computing, and hierarchical physical design. Therefore, the present disclosure relates generally to the fields of electrical engineering and material science.

### BACKGROUND

The automated electronics design toolchain has extensively driven modern digital IC design, owing to the increased design rule complexity of sub-10 nm technology. However, the Field Programmable Gate Arrays (FPGAs) design has long been an exception to this and has used a full-custom approach. It is a general belief that the custom approach enables aggressive optimization of Performance, Power, and Area (PPA) metric but results in a longer development cycle. On the other hand, the full custom approach requires a shorter development time but poor PPA metrics.

### SUMMARY

A semi-custom design approach provides the best of both methodologies and hardens the primitive FPGA block first, followed by the top-level integration. The success of this approach relies on the floorplan, time budgeting, and placement decisions made very early in the stage, which uses substantial experience and skills. This work presents scalable and adaptive hierarchical floorplanning strategies, to significantly reduce the physical design runtime and enable millions-of-LUT FPGA layout implementations using standard ASIC toolchains.

In one embodiment, a method for rapid prototyping of the Field Programmable Gate Arrays (FPGAs) can comprise generating a global signal netlist comprising feedthrough connections through non-adjacent FPGA modules, to reduce a top-level place and route runtime. In one aspect, the method can comprise selecting a predefined connectivity pattern for the global signals. In another aspect, the method can comprise generating pre-routed feedthrough connections based on the predefined signal connection pattern and the global signal. In another aspect, the method can comprise generating a pre-routed global signal netlist from the pre-routed feedthrough connections.

In another embodiment, an FPGA module can comprise an input pin, a multiple directional routing structure, and an output pin. In one aspect, the input pin can be configured to: receive a pre-routed global signal from a pre-routed global signal source and send the pre-routed global signal to the multiple-directional routing structure. In another aspect, the multiple-directional routing structure can be configured to send the pre-routed global signal to the output pin. In another aspect, the output pin is configured to send the pre-routed global signal through a pre-routed feedthrough connection to a non-adjacent FPGA module.

In yet another embodiment, the FPGA can comprise an FPGA module configured to send a pre-routed global signal to a non-adjacent FPGA module through a pre-routed feedthrough connection identified using a predefined signal connection pattern.

There has thus been outlined, rather broadly, the more important features of the invention so that the detailed description thereof that follows may be better understood, and so that the present contribution to the art may be better appreciated. Other features of the present invention will become clearer from the following detailed description of the invention, taken with the accompanying drawings and claims, or may be learned by the practice of the invention.

### BRIEF DESCRIPTION OF THE DRAWINGS

Features and advantages of the disclosure will be apparent from the detailed description which follows, taken in conjunction with the accompanying drawings, which together illustrate, by way of example, features of the disclosure.

FIG. 1 is an illustration of a field programmable gate array (FPGA) module in coupled to another FPGA module through a feedthrough connection in accordance with an example.

FIG. 2 is an illustration of an FPGA comprising a repetitive block structure of logic blocks (LBs), connection blocks (CBs), and switch blocks (SBs) in accordance with an example.

FIG. 3 is an OpenFPGA framework design flow diagram in accordance with an example.

FIG. 4 is a hierarchical design flow diagram in accordance with an example.

FIG. 5A is an illustration of routing track alignment for a horizontal power grid in accordance with an example.

FIG. 5B is an illustration of routing track alignment for a vertical power grid in accordance with an example.

FIG. 6 is an illustration of the shape and placement of an FPGA module in accordance with an example.

FIG. 7A is an illustration of top-level power grid placement for a horizontal power grid in accordance with an example.

FIG. 7B is an illustration of top-level power grid placement for a vertical power grid in accordance with an example.

FIG. 8 is a chart depicting a runtime comparison of different FPGA sizes in accordance with an example.

FIG. 9 is an illustration of scaling of the FPGA in accordance with an example.

FIG. 10A is an illustration of a predefined signal connection pattern for a reset signal pattern in accordance with an example.

FIG. 10B is an illustration of a predefined signal connection pattern for a reset signal pattern in accordance with an example.

FIG. 10C is an illustration of a predefined signal connection pattern for a scan chain connection in accordance with an example.

FIG. 10D is an illustration of a predefined signal connection pattern for a configuration-chain pattern in accordance with an example.

FIG. 11A is an illustration of a connection structure for a multi-directional routing structure in accordance with an example.

FIG. 11B is an illustration of directional buffering for a multi-directional routing structure in accordance with an example.

FIG. 12 is an illustration of an H-tree implementation in a 4×4 FPGA in accordance with an example.

FIG. 13A is an illustration of a pre-routed clock network for a 2×2 FPGA in accordance with an example.

FIG. 13B is an illustration of buffer placement locations for a 2×2 FPGA in accordance with an example.

FIG. 13C is a graph illustrating buffer location selection with respect to delay and skew in accordance with an example.

FIG. 14 is an illustration of a graphic design system (GDS) view of a top-right 8×8 FPGA grid of a 128×128 FPGA design in accordance with an example.

FIG. 15 is a chart depicting a runtime comparison of different FPGA sizes with different hierarchical design flows in accordance with an example.

FIG. 16 illustrates a general computing system or device that can be employed in accordance with an example.

FIG. 17 depicts a method for reducing a top-level placement and routing (P&R) runtime of an FPGA in accordance with an example.

These drawings are provided to illustrate various aspects of the invention and are not intended to be limiting of the scope in terms of dimensions, materials, configurations, arrangements, or proportions unless otherwise limited by the claims.

### DETAILED DESCRIPTION

While these exemplary embodiments are described in sufficient detail to enable those skilled in the art to practice the invention, it should be understood that other embodiments may be realized and that various changes to the invention may be made without departing from the spirit and scope of the present invention. Thus, the following more detailed description of the embodiments of the present invention is not intended to limit the scope of the invention, as claimed, but is presented for purposes of illustration only and not limitation to describe the features and characteristics of the present invention, to set forth the best mode of operation of the invention, and to sufficiently enable one skilled in the art to practice the invention. Accordingly, the scope of the present invention is to be defined solely by the appended claims.

### Definitions

In describing and claiming the present invention, the following terminology will be used.

The singular forms “a,” “an,” and “the” include plural referents unless the context clearly dictates otherwise. Thus, for example, reference to “an FPGA module” includes reference to one or more of such structures and reference to “selecting” refers to one or more of such operations.

As used herein with respect to an identified property or circumstance, “substantially” refers to a degree of deviation that is sufficiently small so as to not measurably detract from the identified property or circumstance. The exact degree of deviation allowable may in some cases depend on the specific context. The use of “substantially” is equally applicable when used in a negative connotation to refer to the complete or near complete lack of an action, characteristic, property, state, structure, item, or result.

As used herein, “adjacent” refers to the proximity of two structures or elements. Particularly, elements that are identified as being “adjacent” may be either abutting or connected. Such elements may also be near or close to each other without necessarily contacting each other. The exact degree of proximity may in some cases depend on the specific context.

As used herein, the term “about” is used to provide flexibility and imprecision associated with a given term, metric or value. The degree of flexibility for a particular variable can be readily determined by one skilled in the art. However, unless otherwise enunciated, the term “about” generally connotes flexibility of less than 2%, and most often less than 1%, and in some cases less than 0.01%.

As used herein, a “pre-defined connectivity pattern” is a pattern that identifies at least one signal route from at least one signal source to at least one signal sink. The term “predefined signal connection pattern” is also used synonymously.

As used herein, “pre-routed” is a property obtained without using top-level placement and routing. In one example, a “pre-routed feedthrough connection” is a feedthrough connection generated without using top-level placement-and-routing. In another example, a “pre-routed global signal” is a global signal connectivity that is obtained without using top level placement and routing. In another example, a “pre-routed global signal netlist” is global signal netlist that is obtained without using top-level placement and routing.

As used herein, “top-level placement and routing” is the placement and the routing that occurs during top level integration. In one example “top-level placement and routing” is the placement and routing that occurs for an FPGA module that is dependent on the placement and routing of another FPGA module.

As used herein, “top-level placement and routing runtime” is the duration of time to perform top-level placement and routing.

As used herein, a “global signal netlist” is a description of the signal flow of the global signals through the connectivity of an electronic circuit (e.g., an FPGA) that includes a list of the electronic components of the electronic circuit that the global signal flows through and the connections between the components of the electronic circuit that the global signal flows through.

As used herein, a “feedthrough connection” is a connection between non-adjacent FPGA modules.

As used herein, an “FPGA module” is a repeatable structure including at least one of a logic block (LB), a connection block (CB), a switch block (SB), and a combination thereof. In one example, a logic block can comprise one or more logic elements (LEs) and a local routing architecture as fast interconnects between LE pins. In another example, the CBs can connect routing tracks to LB inputs. In yet another example, the SBs can provide interconnection between routing tracks.

As used herein, an “adjacent FPGA module” is a second FPGA module that is coupled to a first FPGA module without an intervening FPGA module between the first FPGA module and the second FPGA module.

As used herein, a “non-adjacent FPGA module” is a second FPGA module that is not adjacent to a first FPGA module.

As used herein, a “multiple directional routing structure” is a routing structure wherein the input and output pins of the signal can be duplicated to two or more directions (e.g., West, North, East, South). In one example, the multiple directional routing structure can be an “all directional routing structure” when the input and output pins of the signal can be duplicated to four directions (e.g., West, North, East, and South).

As used herein, a “directional buffer” is a buffer coupled between the input and output pins of a routing structure.

As used herein, “estimated wire load” is a calculation based on the wire length and the number of buffers between a first structure and a second structure.

As used herein, “pre-routing synthesis” is synthesis that occurs without using top level integration.

As used herein, a “buffer size” is a measure of the delay that a buffer provides.

As used herein, a “buffer insertion operation” is an operation used to insert buffers to equalize delays from a signal source to a signal sink.

As used herein, “solution pruning” is deleting a possible solution from a physical design.

As used herein, a “global signal” is a signal that flows from a signal source in a first FPGA module to a signal sink in a second FPGA module, wherein the second FPGA module is different from the first FPGA module.

As used herein, a “reset signal” is a synchronization signal that sets all storage elements, or a subset of storage elements, to a pre-defined state.

As used herein, a “flip-flop chain signal” is a signal between one or more flip-flops in an FPGA.

As used herein, a “clock net signal” is a clock signal through two or more FPGA modules in an FPGA.

As used herein, an “H-tree structure” is a signal connection pattern that directs a signal to flow from a signal source to a signal sink in a first direction and in a second direction that is in an opposite direction from the first direction, wherein the first direction and second directions each branch into third and fourth directions, wherein the third direction is at about a 90° angle to the first direction and the fourth direction is in an opposite direction from the third direction.

As used herein, a “nested H-tree” is an H-tree structure that is included within a larger H-tree structure.

As used herein, a “routing track” is a repetitive guiding structure to route nets across an FPGA.

As used herein, “routing track spacing” is a spacing between one or more routing tracks.

As used herein, a “contacted poly-pitch distance” is the transistor gate pitch which is minimum distance from the gate of a first transistor to the gate of an adjacent transistor.

As used herein, a “channel size” is the distance between adjacent instances (e.g., the distance between an LB and adjacent SB, the distance between an LB and adjacent CB, the distance between an SB and an adjacent CB, or the like).

As used herein, comparative terms such as “increased,” “decreased,” “better,” “worse,” “higher,” “lower,” “enhanced,” “improved,” “maximized,” “minimized,” and the like refer to a property of a device, component, composition, or activity that is measurably different from other devices, components, compositions, or activities that are in a surrounding or adjacent area, that are similarly situated, that are in a single device or composition or in multiple comparable devices or compositions, that are in a group or class, that are in multiple groups or classes, or as compared to an original or baseline state, or the known state of the art. For example, an FPGA with “reduced” runtime can refer to an FPGA which has a lower runtime duration than one or more other FPGAs. A number of factors can cause such reduced runtime, including materials, configurations, architecture, connections, etc.

Reference in this specification may be made to devices, structures, systems, or methods that provide “improved” performance. It is to be understood that unless otherwise stated, such “improvement” is a measure of a benefit obtained based on a comparison to devices, structures, systems or methods in the prior art. Furthermore, it is to be understood that the degree of improved performance may vary between disclosed embodiments and that no equality or consistency in the amount, degree, or realization of improved performance is to be assumed as universally applicable.

In this disclosure, “comprises,” “comprising,” “containing” and “having” and the like can have the meaning ascribed to them in U.S. Patent law and can mean “includes,” “including,” and the like, and are generally interpreted to be open ended terms. The terms “consisting of” or “consists of” are closed terms, and include only the components, structures, steps, or the like specifically listed in conjunction with such terms, as well as that which is in accordance with U.S. Patent law. “Consisting essentially of” or “consists essentially of” have the meaning generally ascribed to them by U.S. Patent law. In particular, such terms are generally closed terms, with the exception of allowing inclusion of additional items, materials, components, steps, or elements that do not materially affect the basic and novel characteristics or function of the item(s) used in connection therewith. For example, trace elements present in a composition, but not affecting the compositions nature or characteristics would be permissible if present under the “consisting essentially of” language, even though not expressly recited in a list of items following such terminology. When using an open-ended term, like “comprising” or “including,” in the written description it is understood that direct support should be afforded also to “consisting essentially of” language as well as “consisting of” language as if stated explicitly and vice versa.

The terms “first,” “second,” “third,” “fourth,” and the like in the description and in the claims, if any, are used for distinguishing between similar elements and not necessarily for describing a particular sequential or chronological order. It is to be understood that any terms so used are interchangeable under appropriate circumstances such that the embodiments described herein are, for example, capable of operation in sequences other than those illustrated or otherwise described herein.

The term “coupled,” as used herein, is defined as directly or indirectly connected in a biological, chemical, mechanical, electrical, or nonelectrical manner. “Directly coupled” structures or elements are in contact with one another. In this written description, recitation of “coupled” or “connected” provides express support for “directly coupled” or “directly connected” and vice versa. Objects described herein as being “adjacent to” each other may be in physical contact with each other, in close proximity to each other, or in the same general region or area as each other, as appropriate for the context in which the phrase is used.

As used herein, a plurality of items, structural elements, compositional elements, and/or materials may be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary.

As used herein, the term “at least one” of is intended to be synonymous with “one or more of.” For example, “at least one of A, B and C” explicitly includes only A, only B, only C, or combinations of each.

Numerical data may be presented herein in a range format. It is to be understood that such range format is used merely for convenience and brevity and should be interpreted flexibly to include not only the numerical values explicitly recited as the limits of the range, but also to include all the individual numerical values or sub-ranges encompassed within that range as if each numerical value and sub-range is explicitly recited. For example, a numerical range of about 1 to about 4.5 should be interpreted to include not only the explicitly recited limits of 1 to about 4.5, but also to include individual numerals such as 2, 3, 4, and sub-ranges such as 1 to 3, 2 to 4, etc. The same principle applies to ranges reciting only one numerical value, such as “less than about 4.5,” which should be interpreted to include all of the above-recited values and ranges. Further, such an interpretation should apply regardless of the breadth of the range or the characteristic being described.

Any steps recited in any method or process claims may be executed in any order and are not limited to the order presented in the claims. Means-plus-function or step-plus-function limitations will only be employed where for a specific claim limitation all of the following conditions are present in that limitation: a) “means for” or “step for” is expressly recited; and b) a corresponding function is expressly recited. The structure, material or acts that support the means-plus function are expressly recited in the description herein. Accordingly, the scope of the invention should be determined solely by the appended claims and their legal equivalents, rather than by the descriptions and examples given herein.

Occurrences of the phrase “in one embodiment,” or “in one aspect,” herein do not necessarily all refer to the same embodiment or aspect. Reference throughout this specification to “an example” means that a particular feature, structure, or characteristic described in connection with the example is included in at least one embodiment. Thus, appearances of the phrases “in an example” in various places throughout this specification are not necessarily all referring to the same embodiment.

### Example Embodiments

An initial overview of invention embodiments is provided below, and specific embodiments are then described in further detail. This initial summary is intended to aid readers in understanding the technological concepts more quickly but is not intended to identify key or essential features thereof, nor is it intended to limit the scope of the claimed subject matter.

Physical design for Field Programmable Gate Arrays (FPGAs) is challenging and time-consuming because of the use of a full-custom approach for aggressively increasing the Performance, Power, and Area (P.P.A.) of the FPGA design. The growing number of FPGA applications could use different architectures and shorter development cycles. The use of an automated toolchain may be useful to reduce end-to-end development time. Therefore, a balance can be provided between the runtime of the device and the performance of the device.

Using an Application Specific Integrated Circuit (ASIC) toolchain with a standard cell library to shorten the FPGA design cycle does not necessarily increase the performance or decrease the runtime of the FPGA. In one example, use of ASIC toolchains resulted in a 50-60% degradation in the performance compared to a full-custom implementation. Other semi-custom approaches used custom-designed cells like transmission gate multiplexers and configuration cells but did not replicate the performance of the full custom approach. Furthermore, these studies failed to consider the scale used for modern FPGA applications (e.g., an FPGA with more than 100 k lookup tables (LUTs)). Therefore, a simple extension of previous studies for large-scale FPGAs is either infeasible or results in an exponential increase in the runtime.

Scalable and adaptive hierarchical floor-planning strategies can significantly reduce the physical design runtime and can enable millions-of-LUT FPGA layout implementations using ASIC toolchains. This approach uses the repetitiveness of the physical design and performs feedthrough connections for global and clock nets to reduce the runtime from top-level integration.

Full-chip layouts for a modern FPGA fabric with a logic capacity ranging from 40 to 100 k LUTs were implemented on commercial 12 nm technology using a hierarchical design flow and ASIC design tools. The results show that the physical implementation of a 128 k-LUT FPGA fabric can be achieved in a runtime of about 24 hours. When compared to previous tests, a runtime reduction of about 8× was obtained for a 2.5 k LUT FPGA device.

The reduction in runtime was achieved by pre-planning the high-fanout nets and clock network. In addition, the clock and global signal latency was further enhanced by a Post-Placement and Routing (P&R) buffer sizing strategy.

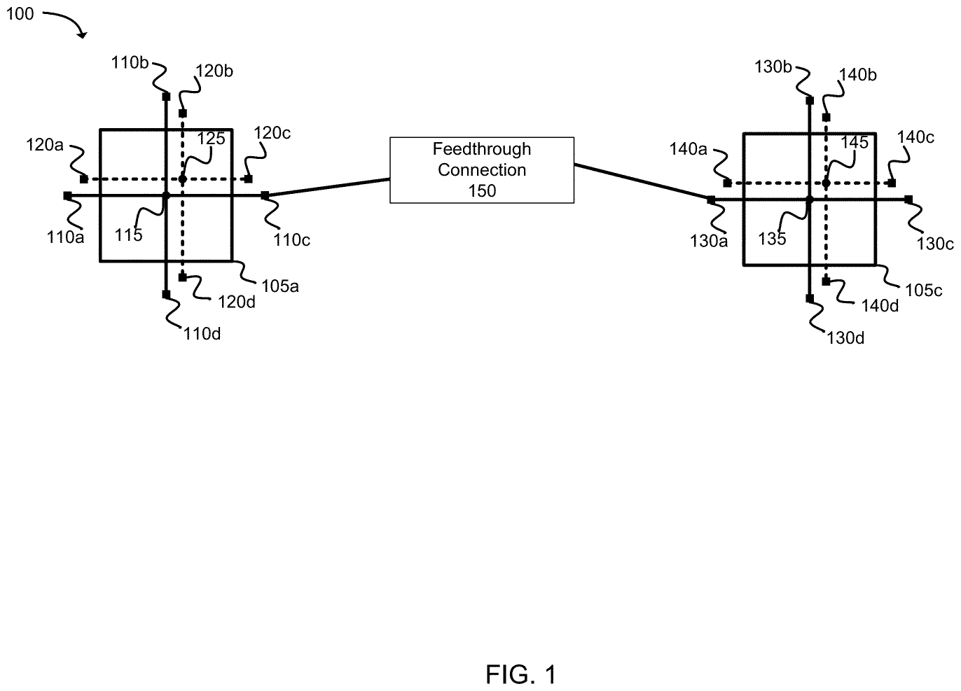

In one embodiment, as illustrated with reference to FIG. 1, an FPGA 100 can comprise an FPGA module 105a that can be configured to send a pre-routed global signal to a non-adjacent FPGA module 105c through a pre-routed feedthrough connection 150 identified using a predefined signal connection pattern. In one aspect, the FPGA module 105a can comprise an input pin (e.g., 110a, 110b, 110c, and 110d), a multiple directional routing structure, and an output pin (e.g., 120a, 120b, 120c, 120d). In one aspect, the multidirectional routing structure can comprise an all-directional routing structure.

In one example, the input pin (e.g., 110a, 110b, 110c, and 110d) can be configured to: receive a pre-routed global signal from a pre-routed global signal source and send the pre-routed global signal to the multiple-directional routing structure. In another aspect, the multiple-directional routing structure can be configured to send the pre-routed global signal to the output pin (e.g., 120a, 120b, 120c, 120d). In one example the input pins (110a, 110b, 110c, and 110d) of the signal from multiple directions (e.g., North, East, West, South) can be coupled to provide a single input net 115. This single input net 115 can be routed to a single output net 125 or to each output pin 120a, 120b, 120c, 120d through a buffer.

In another aspect, the output pin (e.g., 120a, 120b, 120c, 120d) can be configured to send the pre-routed global signal through a pre-routed feedthrough connection 150 to a non-adjacent FPGA module 105c. In one example, the non-adjacent FPGA module 105c can comprise an input pin (e.g., 130a, 130b, 130c, and 130d), a multiple directional routing structure, and an output pin (e.g., 140a, 140b, 140c, 140d). In one aspect, the multidirectional routing structure can comprise an all-directional routing structure. In one example the input pins (130a, 130b, 130c, and 130d) of the signal from multiple directions (e.g., North, East, West, South) can be coupled to provide a single input net 135. This single input net 135 can be routed to a single output net 145, or to each output pin 120a, 120b, 120c, 120d through a buffer.

In another example, the FPGA module 105a can comprise a directional buffer between the input pin (e.g., 110a, 110b, 110c, 110d) and output pin (e.g., 120a, 120b, 120c, 120d). In one example, the directional buffer can be selected based on estimated wire load from pre-routing synthesis. In one aspect, a buffer size for the directional buffer can selected using a buffer insertion operation, solution pruning, or a combination thereof.

In one example, the pre-routed global signal can comprise a reset signal, a flip-flop chain signal, a clock net signal, or a combination thereof. In one aspect, the global signal can be a clock net signal. In another aspect, the predefined signal connection pattern can be an H-tree structure. In one aspect, the H-tree structure can include one or more nested H-trees.

In another example, the FPGA can comprise routing track spacing selected to align routing tracks to a selected multiple of a contacted poly pitch (CPP) distance. In another aspect, a channel size between adjacent FPGA modules can be selected to facilitate buffer insertion. In another aspect, at least one of a pitch and a width of a strap is adjusted to metal tracks.

In another embodiment, a method for reducing a top-level placement and routing (P&R) runtime of a field programmable gate array (FPGA) 100 can comprise generating a global signal netlist comprising feedthrough connections 150 through non-adjacent FPGA modules 105a and 105c. In one aspect, the method can comprise selecting a predefined signal connection pattern for the global signal netlist. In another aspect, the method can comprise generating pre-routed feedthrough connections 150 based on the predefined signal connection pattern and the global signal netlist. In another aspect, the method can comprise generating a pre-routed global signal netlist from the pre-routed feedthrough connections 150.

In one example, the method can comprise at least one of estimating an arrival time at an FPGA module 105a, 105c boundary of an FPGA module 105a, 105c without using top-level placement and routing; or placing an FPGA module 105a, 105c without using top-level placement and routing; or synthesizing a clock tree at the FPGA module 105a, 105c without using top-level placement and routing; or routing the FPGA module 105a, 105c without using top-level placement and routing; or inserting filler cells at the FPGA module 105a, 105c without using top-level placement and routing, the like, or a combination thereof.

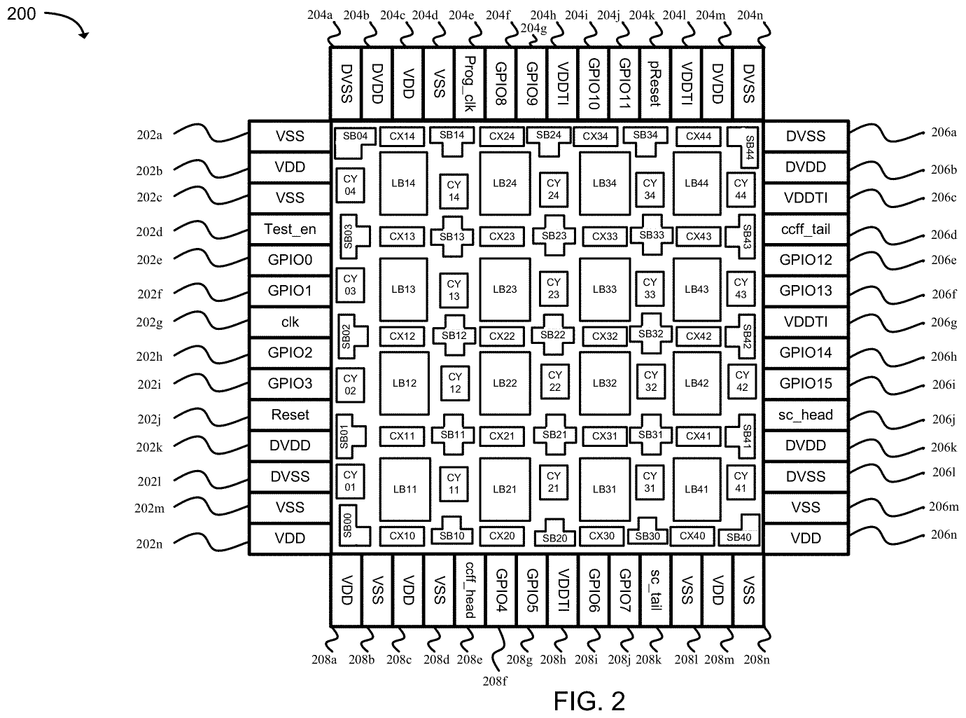

In another example, as illustrated with reference to FIG. 2, a homogeneous FPGA 200 architecture is provided. In one example, the FPGA 200 can comprise repetitive FPGA modules comprising at least one of: a Logic block (LB), a Connection Block (CBs), a Switch

Block (SB), and a combination thereof. A Logic block (e.g., LB11, LB12, LB13, LB14, LB21, LB22, LB23, LB24, LB31, LB32, LB33, LB34, LB41, LB42, LB43, LB44) can comprise: one or more Logic Elements (LEs), and a local routing architecture that can provide fast interconnects between LE pins. A modern LE can adopt fracturable LUTs, hard carry chains, and shift registers to implement complex logic functions efficiently.

In one example, the CBs (e.g., CX14, CX24, CX34, CX44, CX13, CX23, CX33, CX43, CX12, CX22, CX32, CX42, CX11, CX21, CX31, CX41, CY04, CY14, CY24, CY34, CY44, CY03, CY13, CY23, CY33, CY43, CY02, CY12, CY22, CY32, CY42, CY01, CY11, CY21, CY31, CY41) can connect routing tracks to LB (e.g., LB11, LB12, LB13, LB14, LB21, LB22, LB23, LB24, LB31, LB32, LB33, LB34, LB41, LB42, LB43, LB44) inputs while the SBs (SB00, SB01, SB02, SB03, SB04, SB10, SB11, SB12, SB13, SB14, SB20, SB21, SB22, SB23, SB24, SB30, SB31, SB32, SB33, SB34, SB40, SB41, SB42, SB43, SB44) can provide interconnection between routing tracks.

In one example, the FPGA 200 can include numerous IO pins including: VSS 202a, 202c, 202m, 208b, 208d, 2081, 208n, 206m, 204d, VDD 202b, 202n, 208a,m 208c, 208m, 206n, 204c, Clk 202g, Reset 202j, DVDD 204b, 204m, 206b, 206k, 202k, DVSS 202l, 206l, 206a, 204a, 204n, VDDTI 208h, 206g, 206c, 2041, 204h, sc_tail 208k, sc_head 206j, pReset 204k, prog_clk 204e, test_en 202d, ccff_head 208e, ccff_tail 206d, GPIO0 202e, GPIO1 202f, GPIO2 202h, GPIO3 202i, GPIO4 208f, GPIOS 208g, GPIO6 208i, GPIO7 208j, GPIO8 204f, GPIO9 204g, GPIO10 204i, GPIO11 204j, GPIO12 206e, GPIO13 206f, GPIO14 206h, GPIO15 206i, the like, or a combination thereof.

Even though electronic design automation (EDA) tools have increased, multilevel hierarchical design remains a tedious and time-consuming activity. Various commercial tools provide rudimentary support for hierarchical design, but implementing such tools is difficult. Because unplanned design can introduce multiple timing and design rule violations when top-level integration is performed, multiple design iterations may result. Therefore, meticulous pre-planning and data management can be used to reduce the number of design iterations.

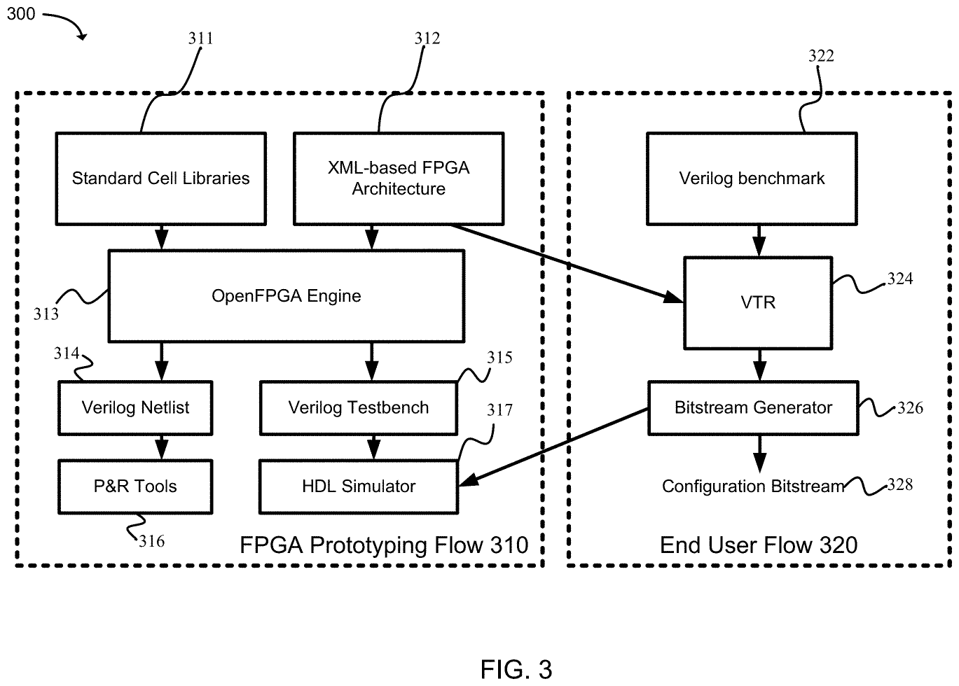

In another example, as illustrated in FIG. 3, a flow diagram 300 for FPGA prototyping flow and end user flow is provided. In one example, a tool suite 313 (e.g., OpenFPGA) can be based on the Versatile Place and Route (VPR) tool and used in the FPGA prototyping flow 310. The tool suite 313 can extend the VPR toolchain's capability beyond standard cell libraries 311 and Extensible Markup Language (XML)-based FPGA architecture 312 by allowing architecture customization and generating a modular hardware description language (HDL) (e.g., Verilog, VHDL) netlist 314 and P&R tools 316. Moreover, the tool suite can generate a set of random and formal testbenches (e.g., a Verilog testbench 315) and HDL simulators 317, which can be used for functional verification of a Pre-P&R or Post-P&R netlist. In one example, in the end-user flow 320, the FPGA can be configured using a Verilog benchmark 322 used with a Verilog-to-Routing (VTR) project 324 and a bitstream generator 326 to generate a configuration bitstream 328.

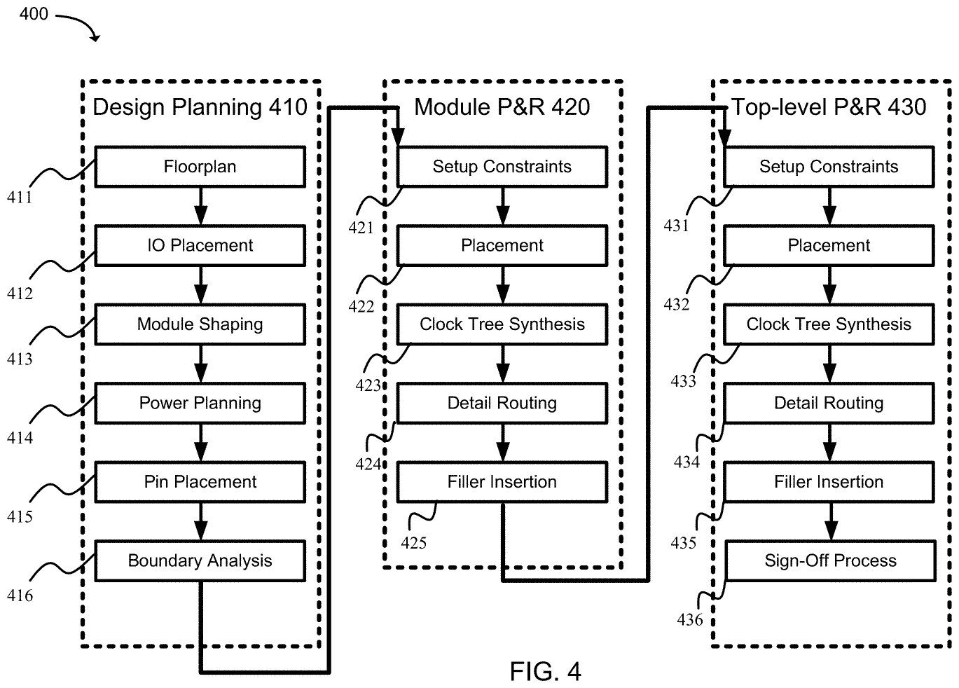

As illustrated in FIG. 4, an example of hierarchical design flow 400 enabled by ASIC tools is provided. The hierarchical design flow can start with multi-level physical hierarchy definitions. In the design planning 410 stage, floorplan 411 operations can include: (i) setting the shape and dimensions of the core, (ii) linking to technology libraries, (iii) defining the IO placement area, and (iv) creating metal routing tracks. Furthermore, input/output (IO) placement 412 operations can include placing the IO cells and pad-fillers around the periphery and the corners of the core. In addition, FPGA module shaping 413 operations can include setting the shape and size of the child FPGA modules and performing child FPGA module placement relative to parent FPGA modules.

In another example, power planning 414 operations can include creating the power grid from the global perspective and pushing the grid segments overlapping the FPGA modules to lower the hierarchy to ensure consistency while performing top-level integration. In one example, pin placement 415 operations can include performing a coarse placement of cells in each child FPGA module and routing boundary nets roughly to estimate the pin placement. In another example, boundary analysis operations 416 can include estimating the driving cell and capacitive load on the FPGA module's input and output pins, respectively, and annotating the input and output delays for the inter-FPGA module sequential paths.

In one example, after the design planning stage 410, the FPGA module placement and routing (P&R) stage 420 can commence in which each FPGA module can be placed and routed independently. In the module P&R stage 420, various operations can be included such as setup constraint operations 421, placement operations 422, clock tree synthesis operations 423, detail routing operations 424, and filler insertion operations 425.

In another example, after the module P&R stage 420, the top-level P&R stage 430 can commence with various operations including setup constraints operations 431, placement operations 432, clock tree synthesis operations 433, detail routing operations 434, filler insertion operations 435, and sign-off process operations 436.

The hierarchical design flow 400 approach may not provide adequate Quality of Results (QoR) for FPGA physical design when the ASIC tools do not use the repetitive structure of FPGA. Consequently, an unplanned floorplan can result in irregular placement of adjacent blocks. Therefore, various operations in the hierarchical design flow 400 approach having inadequate QoR can be replaced with a different automated script. This script can be based on the repetitive operations throughout the FPGA to provide a significant reduction in the design flow runtime.

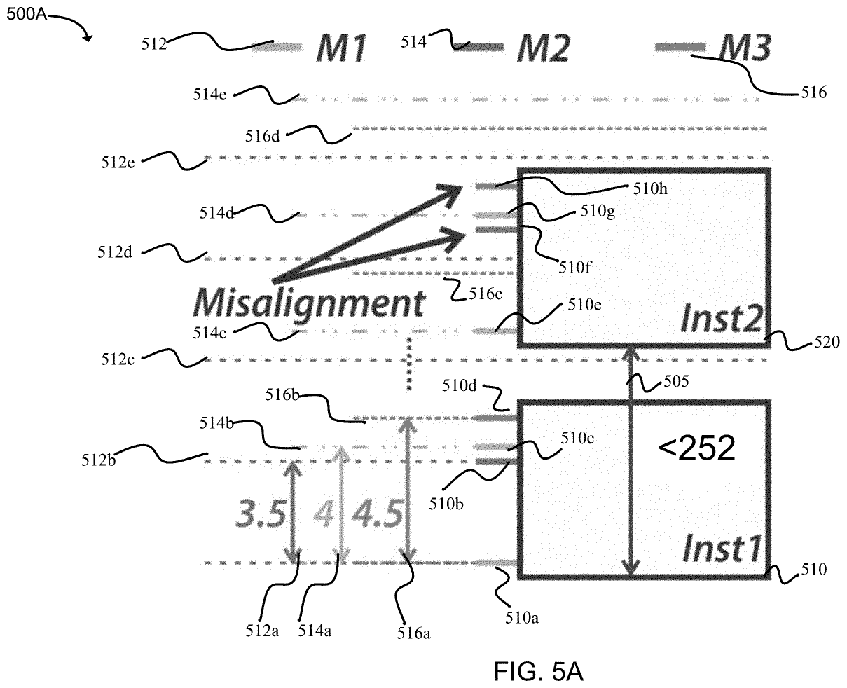

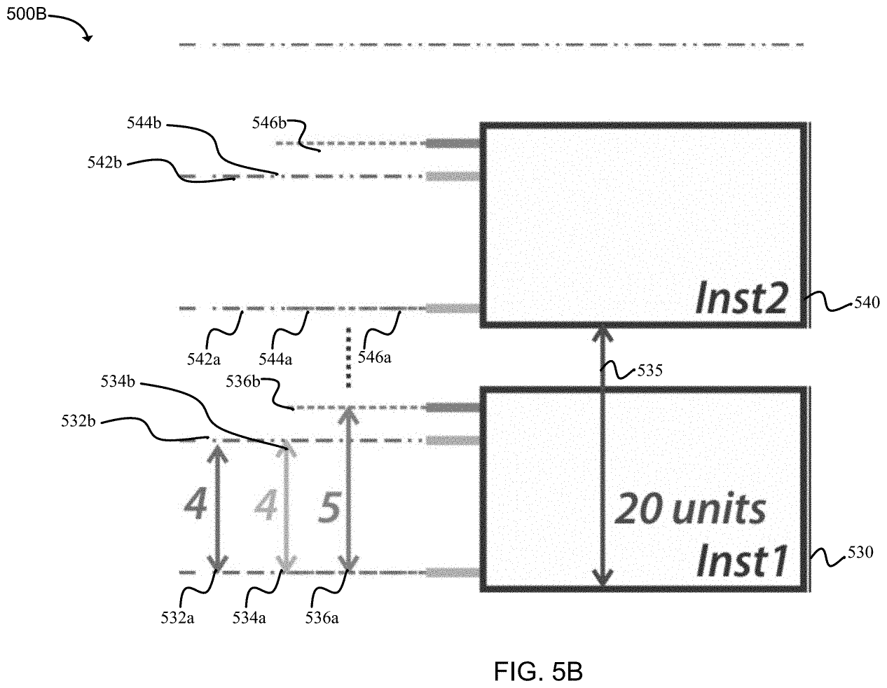

In one example, as illustrated in FIGS. 5A and 5B, the routing can be performed with routing tracks (e.g., M1 512 having instances 512a to 512e, M2 514 having instances 514a to 514e, and M3 516 having instances 516a to 516d), which are consistent guiding structures to route nets across the fabric. The pin (e.g., 510a, 510b, 510c, 510d, 510e, 510f, 510g, and 510h) placement is also based on the intersection of routing tracks (e.g., M1 512 having instances 512a to 512e, M2 514 having instances 514a to 514e, and M3 516 having instances 516a to 516d) with the boundary of the FPGA module 510, 520. The repetitiveness of these guiding patterns (e.g., routing tracks M1 512, M2 514, M3 516) can be used to align the pins (e.g., 510a, 510b, 510c, 510d, 510e, 510f, 510g, and 510h) to the routing tracks M1 512, M2 514, M3 516. In one aspect, the routing tracks can be based on the metal's minimum spacing design rule. When the routing tracks are based on the metal's minimum spacing design rule, the consequent values do not provide track consistency across the fabric which can result in a routing track that is uneven.

In another example, as illustrated in FIGS. 5A and 5B, an FPGA 500A can have three metal tracks (e.g., M1, M2, M3) with a spacing of 3.5, 4.0, and 4.5 units. The FPGA module instances Inst1 510 and Inst2 520 can be placed vertically with a spacing 505 from the bottom boundary of 510 to the bottom boundary of 520 and a narrow spacing between them. In this case, the pins 510a, 510b, 510c, and 510d of Inst1 510 can be aligned to the metal tracks M1 512, M2 514, M3 516 as shown by metal track 514a and pin 510a, metal track 512b and pin 510b, metal track 514b and pin 510c, and metal track 516b and pin 510d. In contrast, the pins 510e, 510f, 510g, and 510h of Inst2 520 may not be aligned to the metal tracks M1 512, M2 514, M3 516 as shown by metal track 512d and pin 510f, and metal track 516d and pin 510h. The misalignment between metal tracks M1 512, M2 514, M3 516 and pins 510a, 510b, 510c, 510d, 510e, 510f, 510g, and 510h can reduce the pin density and result in a design rule violation when top-level integration is performed. In one example, to achieve correct alignment, the pitch 505 between both instances 510 and 520 can be 252 units (which is the least common multiple of 3.5, 4, and 4.5) to facilitate: (i) adequate spacing between the FPGA modules 510 and 520, and (ii) low area density.

In one example, to provide repetitive metal tracks, an FPGA 500B can have metal track spacing 535 that is increased as shown in FIG. 5B. The M2 track (e.g., 532a, 532b, 542a, 542b) is aligned with the M1 track (e.g., 534a, 534b, 544a, 544b) by changing the spacing of the M2 to 4 (e.g., the distance between 532a and 532b). In comparison, the M3 track (e.g., 536a, 536b, 546a, 546b) can be aligned every 8 or 20 tracks by changing the spacing of the M3 track (e.g., 536a, 536b, 546a, 546b) to 8 units or 5 units, respectively. Therefore, there can be a trade-off between the track alignment distance and the density of the tracks.

In one example, the track alignment for Inst1 530 can be about the same as the alignment for Inst2 540 when the spacing of a metal track is selected to provide alignment between the pins of Inst2 540 and the metal tracks. In one example, the routing track spacing can be increased, reduced, or otherwise adjusted to align the routing tracks (e.g., M1, M2, M3) to a selected multiple (e.g., 2×, 3×, 4×, 5×, 6×, 7×, 8×, 9×, 10×, or the like) of a contacted poly pitch (CPP) distance. In one example, a routing track (e.g., the M1 track) can be used as a reference when the routing track is based on a standard cell library height and one or more horizontal tracks can be aligned to the routing track pitch (e.g., the M1 pitch). In another example, the vertical metal tracks can be aligned to about 2×CPP distance because this distance can be a multiple of CPP value. In one example, increasing the track spacing can decrease the total number of tracks, but when an excessive decrease in the track capacity occurs, the alignment for a selected layer can be skipped by omitting the selected layer during a pin placement operation.

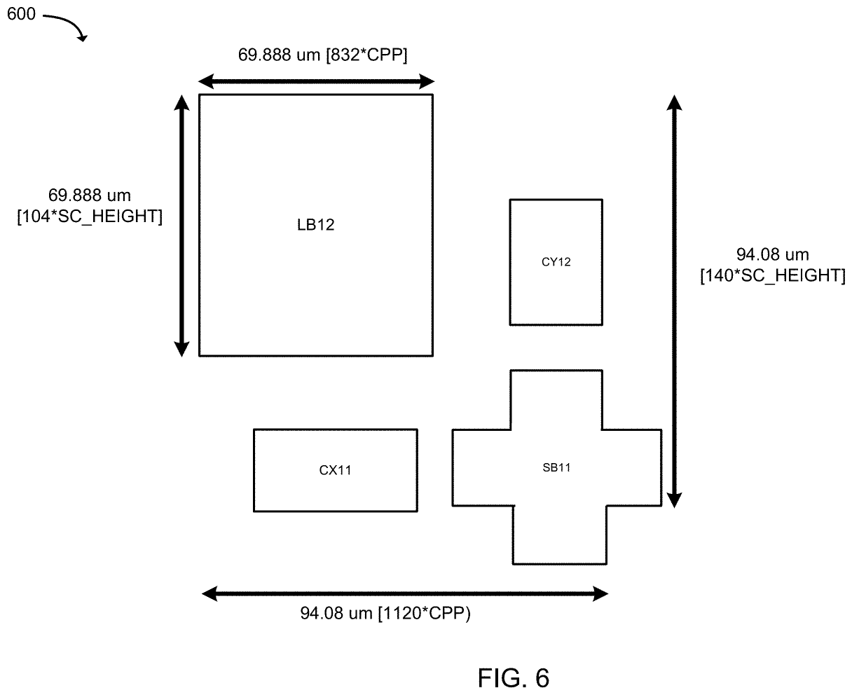

In another example, as illustrated in FIG. 6, ASIC tools can provide a command to shape and place the blocks based on user-defined constraints. Although the command provides good QoR based on the given constraints, the command does not result in a grid structure of FPGA architecture. To better correlate with the VPR grid structure and to reduce the P&R complexity, logic blocks, connection blocks, and switch blocks can be maintained as separate FPGA modules.

In one example, a floorplan can be designed by overriding a default shaping script and using a custom shaping routine. This custom shaping routine can accept the cell area and utilization target (which can be 85%) for each separate FPGA module. The custom shaping routine can generate the shape and location coordinates for each separate FPGA module. As illustrated in FIG. 6, the shape and placement of the FPGA module 600 can include a narrow channel of about 16×CPP and about 4× standard Cell Height (SC_HEIGHT), which can be maintained between each adjacent FPGA module (LB12, CY12, CX11, SB11) to facilitate buffer placement when performing top-level integration. In one example, the channel size between adjacent FPGA modules can be selected to facilitate buffer insertion.

In one example, the height of a logic block LB12 can be about 104×SC_HEIGHT and the width of the logic block LB12 can be about 832×CPP. In another example, the width from a left border of the logic block LB12 to the bottom right border of the connection block CY12 can be about 1120×CPP. In another example, the height from the top border of the logic block LB12 to the bottom border of the connection block CX11 can be about 140×SC_HEIGHT.

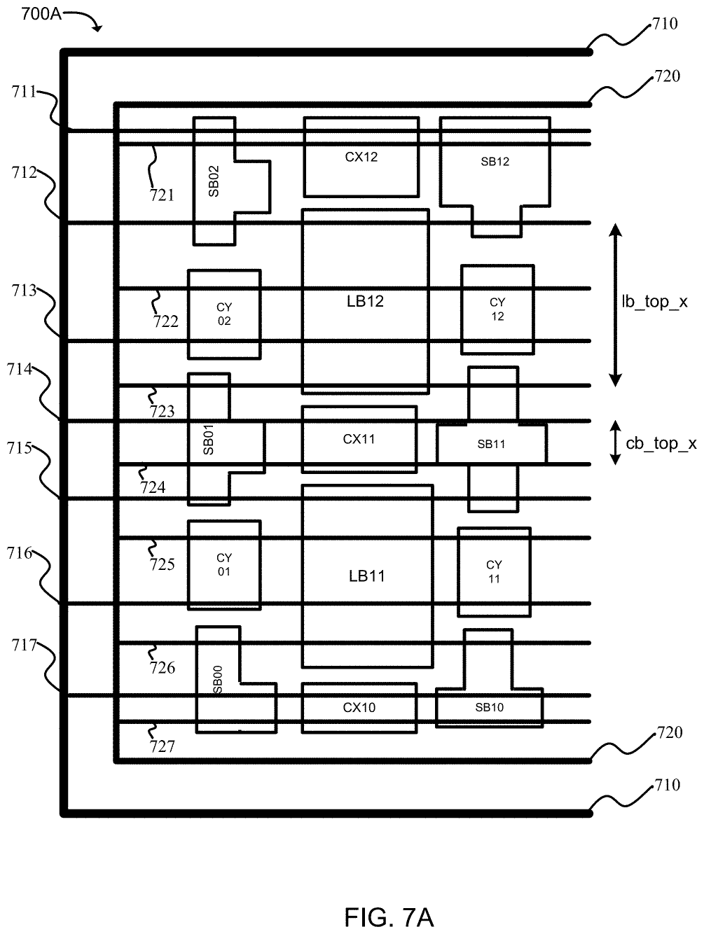

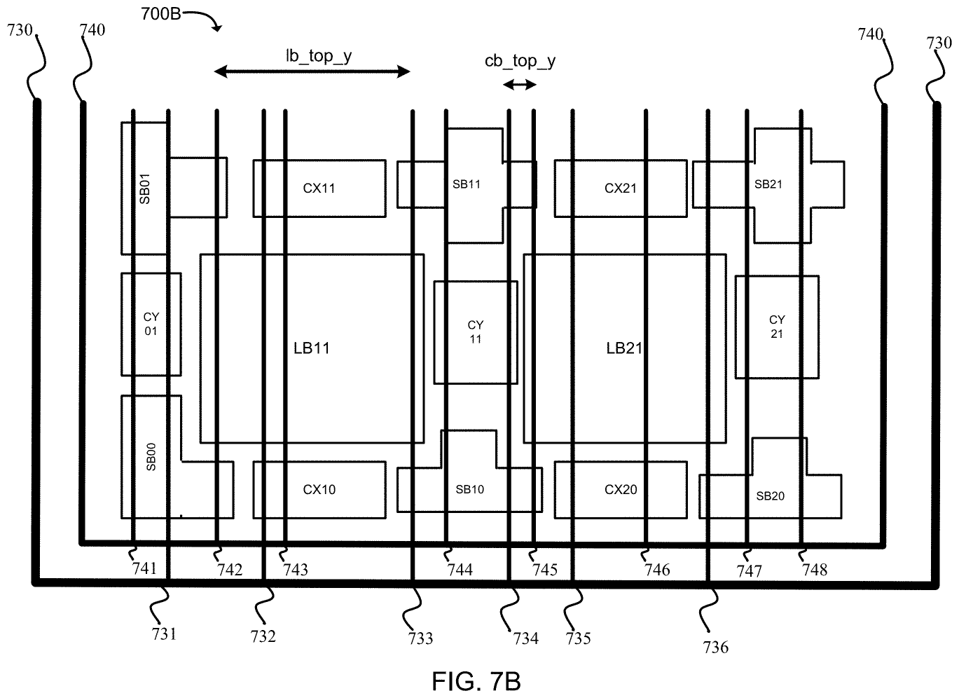

In another example, as illustrated in FIGS. 7A and 7B, a robust and regular power and ground network 700A can be used to limit the IR drop (e.g., the voltage drop). ASIC toolchains can provide numerous ways of customizing the power grid. In one example, an M2-2T rail configuration strategy can support mid-range power density. This configuration can include a top-level power grid 700A, 700B level power and bottom level power grid (not shown). In one example, the top-level power grid 700A, 700B can be a mesh of two metals, Mn and Mn−1, and the bottom grid can be a single M3 metal with dense connections to the cell power rail. The power ring 710, 720 or 730,740 can be created approximately on the edge of the design boundary to maximize the power delivery to the core. The scalable power can be created by aligning each strap (e.g., 711, 712, 713, 714, 715, 716, 717, 721, 722, 723, 724, 725, 726, 727 in 700A and 731, 732, 733, 734, 735, 736, 741, 742, 743, 744, 745, 746, 747, 748 in 700B) to its respective metal track.

In one example, the metal straps (e.g., cb_top_x 714 and 724, lb_top_x 712, 722, 713, 723, cb_top_y 734 and 745, and lb_top_y 742, 732, 743, 733) can be repetitive and aligned to a selected FPGA block or FPGA module (e.g., logic blocks LB11, LB12, LB21, connection blocks CX12, CY02, CY12, CX11, CY01, CY11, CX10, CX21, CX20, or switching blocks SB00, SB01, SB02, SB10, SB11, SB12, SB20, SB21). In one example, the pitch and width of each strap can be adjusted to provide adequate power to each FPGA block or FPGA module. In one example, at least one of a pitch and a width of a strap can be adjusted to a selected FPGA block or FPGA module. In another example, at least one of a pitch and a width of a strap can be adjusted to metal tracks.

In another example, FPGA module pin placement can be provided for a short channel floorplan. A connection from the FPGA module pin that does not connect to its adjacent FPGA module can use top-level routing which can result in congestion in the narrow channel between the FPGA modules. The congestion in the narrow channel between the FPGA modules can be prevented by adding feedthrough connections through the intermediate FPGA modules. ASIC toolchains can be configured to create feedthrough connections through the intermediate FPGA modules. The command can use global routing and user-defined constraints to identify feedthrough nets.

In one example, a tool suite (e.g., OpenFPGA) can provide support to create an HDL netlist (e.g., a Verilog netlist) with these feedthroughs for inter-FPGA module connections, but the global signals can still be a single net on the top-level. In one example, the pin placement can be executed in two separate operations. In a first operation, global signal can be routed to provide feedthrough signals over the FPGA modules. In a second operation, feedthrough creation can be disabled, and pins can be placed for the inter-FPGA module signals.

In another example, an FPGA can create numerous combinational loops through routing resources. These combinational loops can be broken by disabling inter-FPGA module paths on the top-level. However, the constraint can be set up independently in each FPGA module to limit the delay of the inter-FPGA module path. The total delay of the timing path can be calculated from the addition of different segments. Because of the repetitiveness of the FPGA structure, the delays of the timing path can be consistent between FPGA modules. Nonetheless, the global signal can still rely on the estimation of the arrival time at each FPGA module boundary. In one example, the FPGA can be configured to estimate an arrival time at an FPGA module boundary of an FPGA module without using top-level placement and routing.

In one example, various files can be exported for each FPGA module for P&R at the module level. In one example, an HDL netlist file (e.g., a Verilog Netlist), a design constraint file (e.g., Synopsys Design Constraints (SDC)), and a design exchange format (DEF) file can be exported for each FPGA module for P&R. In one example, the individual FPGA modules can be placed and routed simultaneously, as provided in the module P&R 420 depicted in FIG. 4. In one example, an FPGA module can be placed, routed, or a combination thereof without using top-level placement and routing.

In one example, the clock tree can be synthesized independently in each FPGA module in combination with detailed placement and filler cell insertion. In one example, a clock tree can be synthesized at the FPGA module without using top-level placement and routing. In another example, filler cells can be inserted at the FPGA module without using top-level placement and routing.

In one example, logic block routing can use a maximum time because of the FPGA module's size for a logic block; therefore, the abstract views can be extracted at the end of the module P&R flow and instantiated in a top-level design.

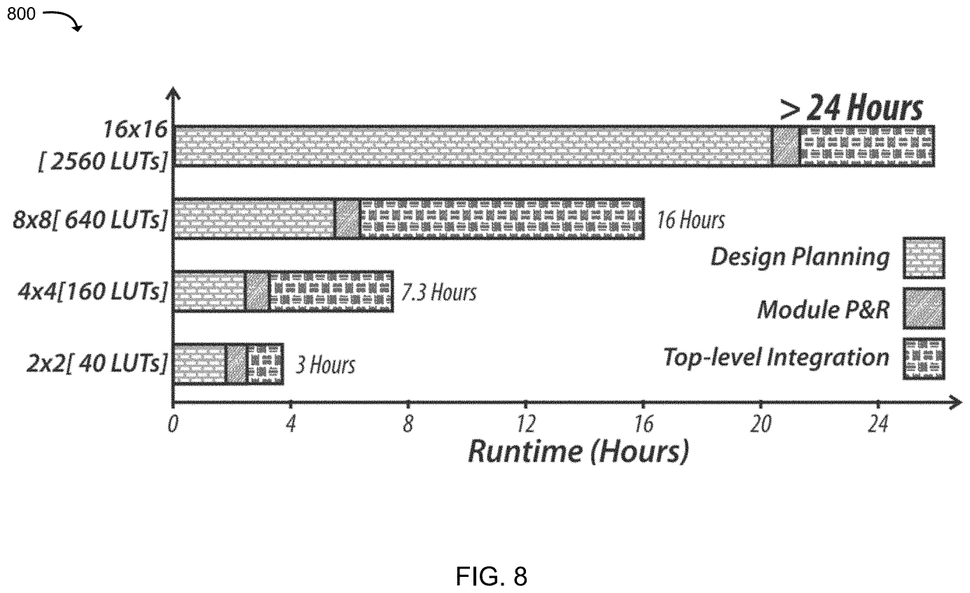

In one example, as depicted in FIG. 8 and described in the proceeding in relation to Example 1, the top-level P&R flow can start by: (i) linking FPGA modules, (ii) defining global signal constraints, (iii) global placement, (iv) and clock tree synthesis. The global placement operation can resolve high fanout nets based on global signal constraints and involve adding buffers in the top-level netlist. The clock tree synthesis can connect the input clock net to the FPGA module's input to achieve minimum or lower global skew and latency targets. The routing operation can result in a low runtime because many nets can have a straight connection on the same layer. In one example, the top-level P&R flow as described can result in an exponential increase in the end-to-end runtime. The module P&R stage runtime can be about constant, but the design planning stage and top-level P&R stage runtime can increase exponentially to result in a total runtime of over 24-hours for an FPGA with 2560 about LUTs.

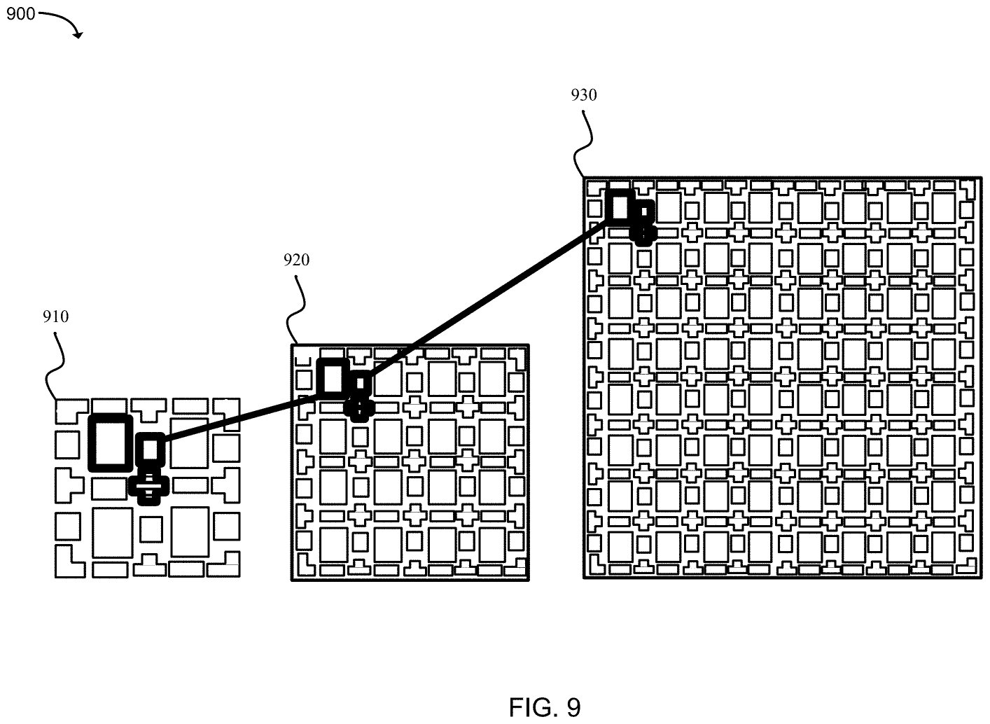

In another example, as illustrated in FIG. 9, design complexity and scaling 900 can result in an exponential increase in the design planning runtime. An FPGA can scale from a 2×2 FPGA 910 to a 4×4 FPGA 920 to an 8×8 FPGA 930 with an increase in the number of

LUTs and the total number of instances. In one example, the number of instances can be equal to about: (4×M×N)+(2×M)+(2×N)+2, wherein M and N can be the number of rows and columns in the FPGA architecture (i.e., the number or logic blocks in a row and the number of logic blocks in a column). Consequently, global design can be extensive as the number of rows and columns increases. Also, timing-driven P&R can directly increase the time to update a timing graph which can occur after each design planning operation. The runtime can be further increased when performing pin placement and boundary timing analysis because of estimation driven by global routing.

In another example, during the top-level P&R stage, placement and clock tree synthesis can use significant time to resolve high fanout global nets and minimize or lower global skew, respectively. The constraint of placing buffers in a narrow channel between the blocks can increase the complexity of these operations and consequently increase the runtime. The factors affecting placement and clock tree synthesis (i.e., high fanout nets & clock sink nodes) can be directly proportional to the size of the LUTs (and quadratically to the FPGA grid size). Therefore, a hierarchical approach may not adequately resolve the increase in total runtime.

In one example, the repetitive structure of the FPGA can be used to reduce the runtime. In one example, a 2×2 FPGA and 4×4 FPGA can be used as a base architecture for the design planning stage to be applied to larger-scale FPGAs. The low runtimes of the 2×2 FPGA and the 4×4 FPGA provides a quick estimation when designing larger FPGAs.

In one example, the runtime of top-level P&R can be reduced by minimizing or eliminating global design during the top-level P&R stage (e.g., placement and clock tree synthesis). The runtime reduction can be achieved by pre-routing global nets through FPGA modules and adding buffers along the signal path. Pre-routed global nets an remove the long wire connection from the top-level and allow minimization of these nets within each FPGA module to avoid top-level P&R.

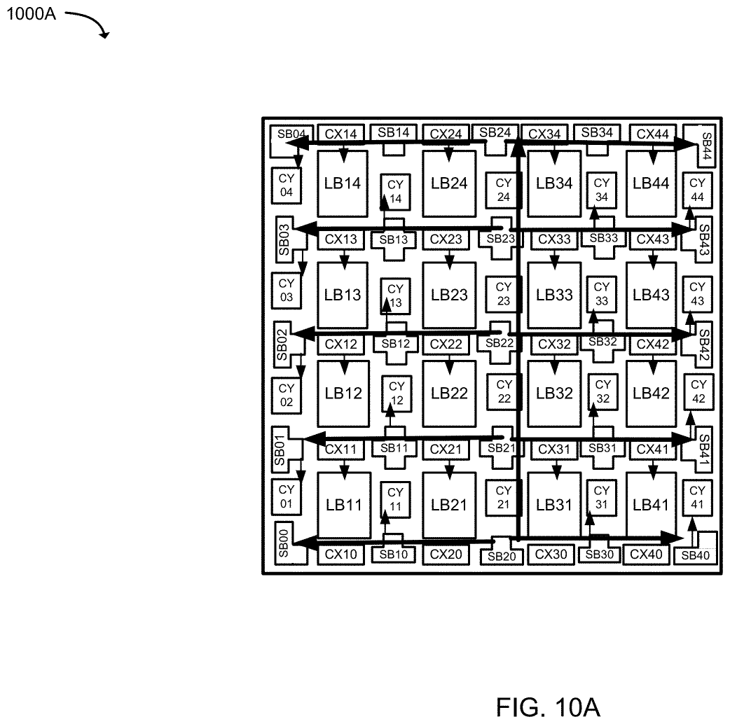

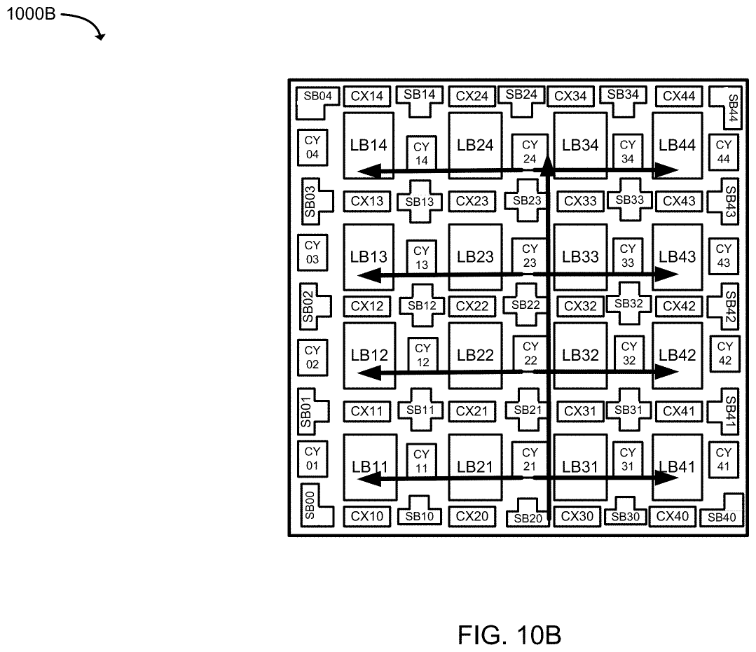

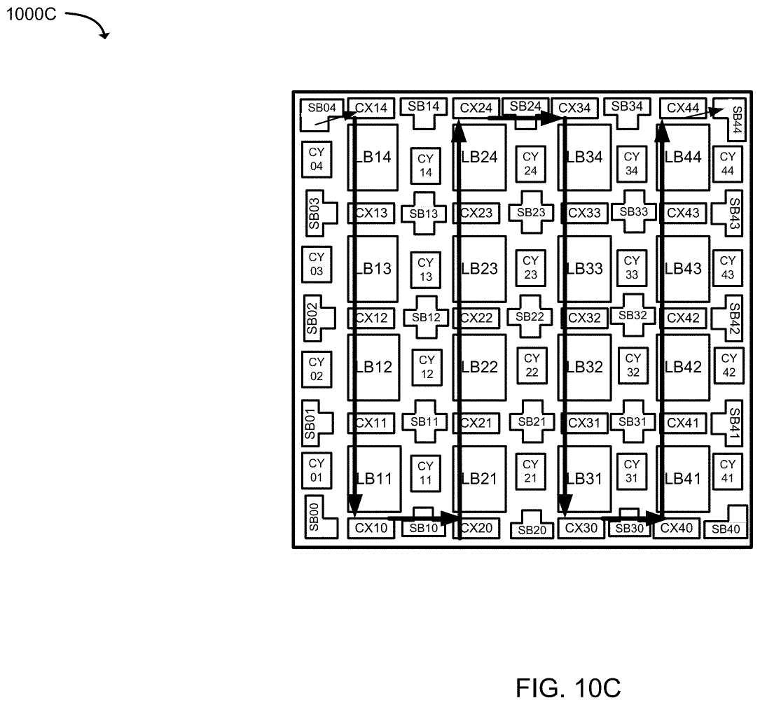

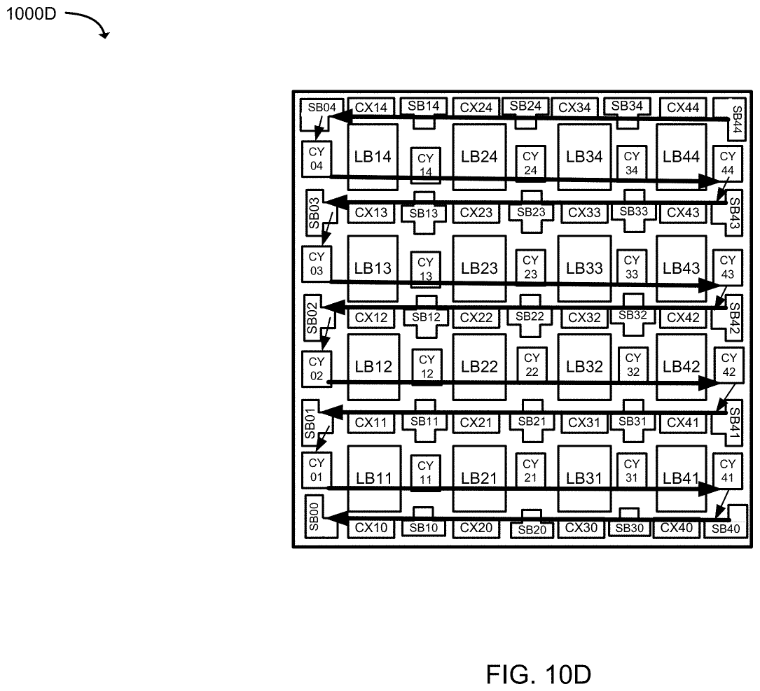

In another example, as illustrated in FIG. 10A to 10D, in FPGA architecture, three types of global signals can include: (1) a reset signal, which can connect to each flip-flop in each FPGA module, (2) a flipflop chain signal, which can create a sequential timing path between FPGA module instances, and (3) a Clock net signal. These signals can be pre-routed using a routine to post-process an HDL netlist (e.g., a Verilog netlist) generated by a tool suite (e.g., OpenFPGA). This routine can select predefined signal connection patterns. In one example, predefined signal connection patterns can be provided by a connectivity file (e.g., a CSV file). In one aspect, feedthrough connections can be extracted from the selected predefined signal connection pattern, and the pre-routed HDL netlist (e.g., a pre-P&R Verilog netlist) can updated based on the feedthrough connections.

In one example, an FPGA can be configured to select a predefined signal connection pattern for a global signal netlist. In another example, an FPGA can be configured to generate a global signal netlist comprising feedthrough connections through non-adjacent FPGA modules. In another example, the FPGA can be configured to generate pre-routed feedthrough connections based on the predefined signal connection pattern and the global signal netlist. In another example, the FPGA can be configured to generate a pre-routed global signal netlist from the pre-routed feedthrough connections. In one example, the global signal can comprise a reset signal, a flip-flop chain signal, a clock net signal, the like, or a combination thereof.

In one example, as illustrated in FIG. 10A, a reset signal pattern for an FPGA 1000A can comprise the signal flow between a signal source and a plurality of signal sinks. In some examples, the signal can flow from one switching block to another switching block through intervening connection blocks or switching blocks. In one aspect, the signal source can be directed through a center column or row of an FPGA to a peripheral row or column of the FPGA. In this example, a signal source can be directed from SB20 to CY21, to SB21, to CY22, to SB22, to CY23, to SB23, to CY24, to SB24, or a combination thereof. In another example, a signal source can be directed from SB20 to CX20, to SB10, to CX10, to SB00, or a combination thereof. In another example, a signal source can be directed from SB20 to CX30, to SB30, to CX40, to SB40, or a combination thereof. In another example, a signal source can be directed from SB21 to CX21, to SB11, to CX11, to SB01, or a combination thereof. In another example, a signal source can be directed from SB21 to CX31, to SB31, to CX41, to SB41, or a combination thereof. In another example, a signal source can be directed from SB22 to CX22, to SB12, to CX12, to SB02, or a combination thereof. In another example, a signal source can be directed from SB22 to CX32, to SB32, to CX42, to SB42, or a combination thereof. In another example, a signal source can be directed from SB23 to CX23, to SB13, to CX13, to SB03, or a combination thereof. In another example, a signal source can be directed from SB23 to CX33, to SB33, to CX43, to SB43, or a combination thereof. In another example, a signal source can be directed from SB24 to CX24, to SB14, to CX14, to SB04, or a combination thereof. In another example, a signal source can be directed from SB24 to CX34, to SB34, to CX44, to SB44, or a combination thereof.

In another example, a signal source can be directed from a switching block to an adjacent connection block. In one example, a signal source can be directed from SB10 to CY11. In another example, a signal source can be directed from SB30 to CY31. In another example, a signal source can be directed from SB11 to CY12. In another example, a signal source can be directed from SB31 to CY32. In another example, a signal source can be directed from SB12 to CY13. In another example, a signal source can be directed from SB32 to CY33. In another example, a signal source can be directed from SB13 to CY14. In another example, a signal source can be directed from SB33 to CY34.

In another example, a signal source can be directed from a connection block to an adjacent logic block. In one example, a signal source can be directed from CX11 to LB11. In another example, a signal source can be directed from CX21 to LB21. In another example, a signal source can be directed from CX31 to LB31. In another example, a signal source can be directed from CX41 to LB41.

In another example, a signal source can be directed from CX12 to LB12. In another example, a signal source can be directed from CX22 to LB22. In another example, a signal source can be directed from CX32 to LB32. In another example, a signal source can be directed from CX42 to LB42.

In another example, a signal source can be directed from CX13 to LB13. In another example, a signal source can be directed from CX23 to LB23. In another example, a signal source can be directed from CX33 to LB33. In another example, a signal source can be directed from CX43 to LB43.

In another example, a signal source can be directed from CX14 to LB14. In another example, a signal source can be directed from CX24 to LB24. In another example, a signal source can be directed from CX34 to LB34. In another example, a signal source can be directed from CX44 to LB44.

In another example, as illustrated in FIG. 10B, a data reset signal pattern for an FPGA 1000B can comprise the signal flow between a signal source and a plurality of signal sinks. In one example, a signal source can be directed from SB20 to CY21, to SB21, to CY22, to SB22, to CY23, to SB23, to CY24, or a combination thereof. In one aspect, the signal source can be directed through a center column or row of an FPGA to a peripheral row or column of the FPGA.

In another example, a signal source can be directed from a connection block to a logic block or another connection block. In one example, a signal source can be directed from CY21 to LB21, to CY11, to LB 11, or a combination thereof. In another example, a signal source can be directed from CY21 to LB31, to CY31, to LB 41, or a combination thereof. In another example, a signal source can be directed from CY22 to LB22, to CY12, to LB 12, or a combination thereof. In another example, a signal source can be directed from CY22 to LB32, to CY32, to LB 42, or a combination thereof. In another example, a signal source can be directed from CY23 to LB23, to CY13, to LB 13, or a combination thereof. In another example, a signal source can be directed from CY23 to LB33, to CY33, to LB 43, or a combination thereof. In another example, a signal source can be directed from CY24 to LB24, to CY14, to LB 14, or a combination thereof. In another example, a signal source can be directed from CY24 to LB34, to CY34, to LB 44, or a combination thereof.

In another example, as illustrated in FIG. 10C, a scan chain signal pattern for an FPGA 1000C can comprise the signal flow between a signal source and one or more signal sinks. In one aspect, the signal source can be directed to a signal sink by passing through one or more logic blocks, connection blocks or switching blocks. In one aspect, the signal source can be directed through each logic block and intervening connection block in a row-by-row order, a column-by-column order, or a combination thereof. In one example, a signal source can be directed from SB04 to CX14, to LB14, to CX13, to LB13, to CX12, to LB12, to CX11, to LB11, to CX10, to SB10, to CX20, to LB21, to CX21, to LB22, to CX22, to LB23, to CX23, to LB24, to CX24, to SB24, to CX34, to LB34, to CX33, to LB33, to CX32, to LB32, to CX31, to LB31, to CX30, to SB30, to CX40, to LB41, to CX41, to LB42, to CX42, to LB43, to CX43, to LB44, to CX44, to SB44, or a combination thereof.

In another example, as illustrated in FIG. 10D, a configuration chain signal pattern for an FPGA 1000D can comprise the signal flow between a signal source and one or more signal sinks. In one aspect, the signal source can be directed to a signal sink by passing through one or more logic blocks, connection blocks, or switching blocks. In one aspect, the signal source can be directed through each logic block and intervening connection block in a row-by-row order, a column-by-column order, or a combination thereof. In another aspect, the signal source can be directed through each switching block and intervening connection block in a row-by-row order, a column-by-column order, or a combination thereof.

In one example, the signal source can be directed from SB44, to CX44, to SB34, to CX34, to SB24, to CX24, to SB14, to CX14, to SB04, or a combination thereof. In another example, the signal source can be directed from SB04, to CY04, to LB14, to CY14, to LB24, to CY24, to LB34, to CY34, to LB44, to CY44, or a combination thereof.

In another example, the signal source can be directed from CY44, to SB43, to CX43, to SB33, to CX33, to SB23, to CX23, to SB13, to CX13, to SB03, or a combination thereof. In another example, the signal source can be directed from SB03, to CY03, to LB13, to CY13, to LB23, to CY23, to LB33, to CY33, to LB43, to CY43, or a combination thereof.

In another example, the signal source can be directed from CY43, to SB42, to CX42, to SB32, to CX32, to SB22, to CX22, to SB12, to CX12, to SB02, or a combination thereof.

In another example, the signal source can be directed from SB02, to CY02, to LB12, to CY12, to LB22, to CY22, to LB32, to CY32, to LB42, to CY42, or a combination thereof.

In another example, the signal source can be directed from CY42, to SB41, to CX41, to SB31, to CX31, to SB21, to CX21, to SB11, to CX11, to SB01, or a combination thereof. In another example, the signal source can be directed from SB01, to CY01, to LB11, to CY11, to LB21, to CY21, to LB31, to CY31, to LB41, to CY41, or a combination thereof.

In another example, the signal source can be directed from CY41, to SB40, to CX40, to SB30, to CX30, to SB20, to CX20, to SB10, to CX10, to SB00, or a combination thereof.

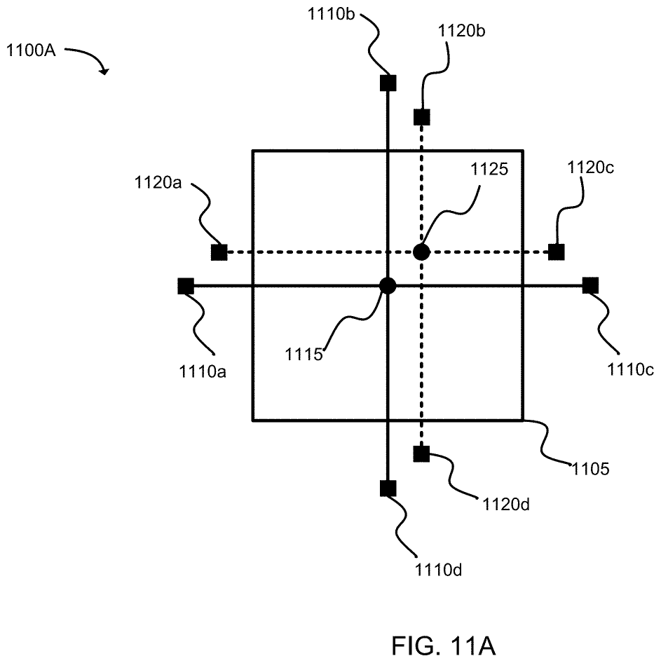

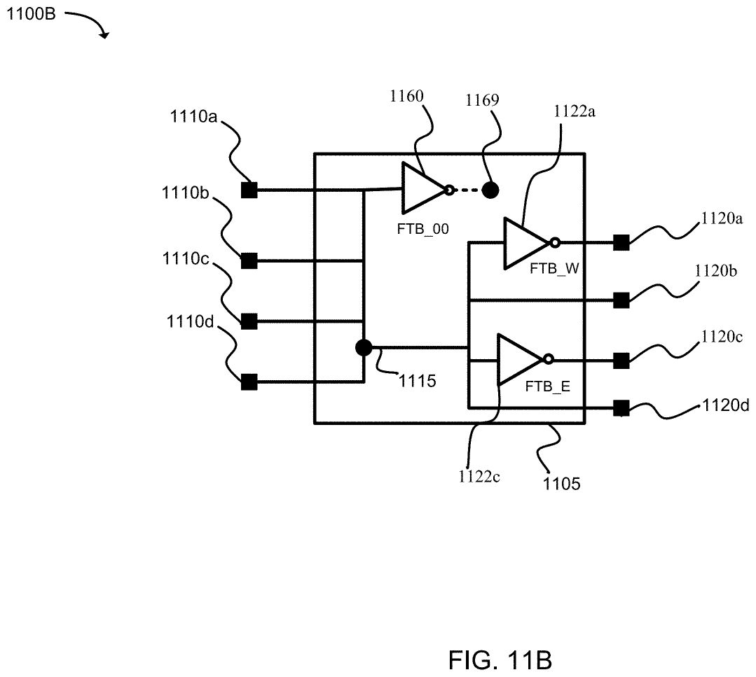

In another example, as illustrated in FIGS. 11A and 11B, at least one FPGA module 1105 can comprise a multiple-directional routing structure 1100A, 1100B. Predefined signal connection patterns can use an FPGA module that has been duplicated based on input pin direction and output pin direction. To avoid duplicating input pin direction and output pin direction, a multi-directional routing structure 1100A, 1100B (e.g., an all-directional routing structure) can be used. The multi-directional routing structure 1100A, 1100B can duplicate the input and output pins of a signal to all four directions (North, East, West, South).

In one example, the FPGA module 1105 can comprise an input pin 1110a, 1110b, 1110c, 1110d, a multiple directional routing structure 1100A, 1100B, and an output pin 1120a, 1120b, 1120c, 1120d. In one aspect, the FPGA module can comprise an output net 1125. In one aspect, the input pin 1110a, 1110b, 1110c, 1110d can be configured to: receive a pre-routed global signal from a pre-routed global signal source, and send the pre-routed global signal to the multiple-directional routing structure 1100A, 1100B. In one aspect, the multiple-directional routing structure 1100A, 1100B can be configured to send the pre-routed global signal to the output pin 1120a, 1120b, 1120c, 1120d or the output net 1125, and the output pin 1120a, 1120b, 1120c, 1120d or the output net 1125 can be configured to send the pre-routed global signal through a pre-routed feedthrough connection to a non-adjacent FPGA module.

In one aspect, a directional buffer 1122a, 1122c can be selected between an input pin 1110a, 1110b, 1110c, 1110d and output pin 1120a, 1120b, 1120c, 1120d for the at least one FPGA module 1105. In one aspect, the directional buffer 1122a, 1122c can be selected based on estimated wire load from pre-routing synthesis.

In one example the input pins (1110a, 1110b, 1110c, 1110d) of the signal from all directions (e.g., North, East, West, South) can be coupled to provide a single input net 1115. This input net 1115 can be routed to each output pin 1120a, 1120b, 1120c, 1120d or the output net 1125 through a buffer 1122a, 1122c. In one example, the output pins on the E and W directions, 1120c and 1120a, can be buffered, but the N and S input pins, 1110b and 1110d, can be coupled directly to the output pins 1120b and 1120d. In one example, connection to an internal circuit 1169 of the FPGA module can be through FTB_00 1160.

In another example, the buffer selection can be based on the Pre-P&R synthesis with an estimated wire load. Each global net considered for pre-routing can use a multi-directional routing structure in each intermediate FPGA module. Creation of specific direction input or output pins for an FPGA module can be skipped when the pin is not used in the selected connection pattern. In one example, an HDL routine (e.g., a Verilog routine) can identify the FPGA modules to create a routing structure based on the selected pattern. The inter-FPGA module connections can be generated in the top-level by connecting the module's directional output pin to the adjacent FPGA module's directional input pin. The input nets can be annotated with a dont_touch instruction to prevent any multi-driver nets or undriven logic gates when performing the module P&R stage.

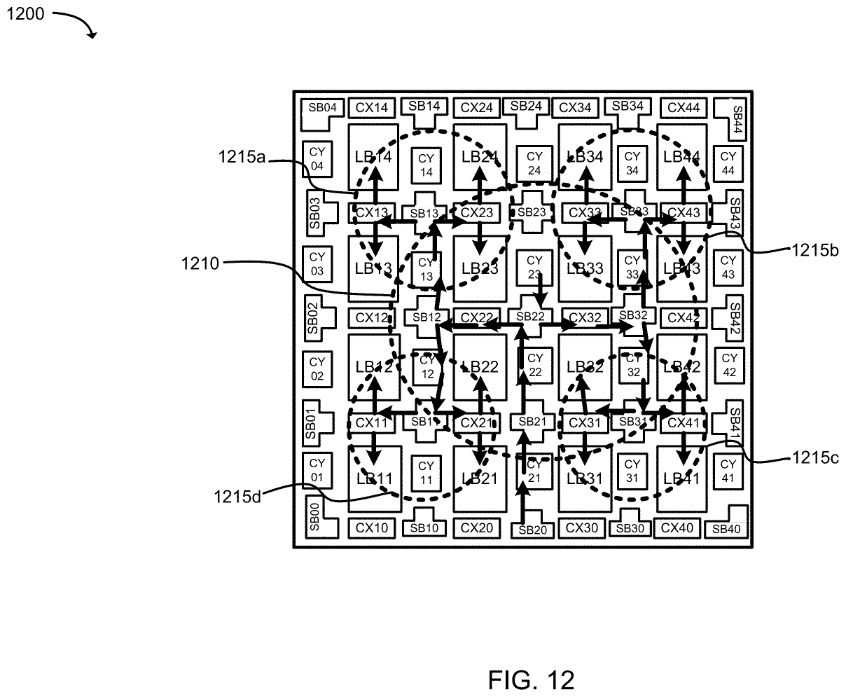

In another example, as illustrated in FIG. 12, the predefined signal connection pattern for the FPGA 1200 (e.g., a 4×4 FPGA) can be an H-tree structure 1210. In one example, the H-tree structure 12109 can include one or more nested H-trees 1215a, 1215b, 1215c, 1215d. In one example, a symmetric H-Tree based clock tree structure can be adopted to pre-route the clock tree. Unlike the global signal in which a single net can route the signal, for clock routing nested H-trees 1215a, 1215b, 1215c, 1215d can be coupled together and can form a larger H-tree structure 1210. In one aspect, each of the nested H-Trees can be buffered separately to allow for a wider range of buffer selection. The feedthrough connection in each block (e.g., logic block, connection block, switching block, or a combination thereof) can be buffered.

In another example, the FPGA modules can be placed and routed as disclosed herein followed by top-level P&R flow without a placement operation or a clock tree synthesis operation. Because a design planning operation can be skipped, an IO placement and power grid creation operation can be added to the top-level P&R stage.

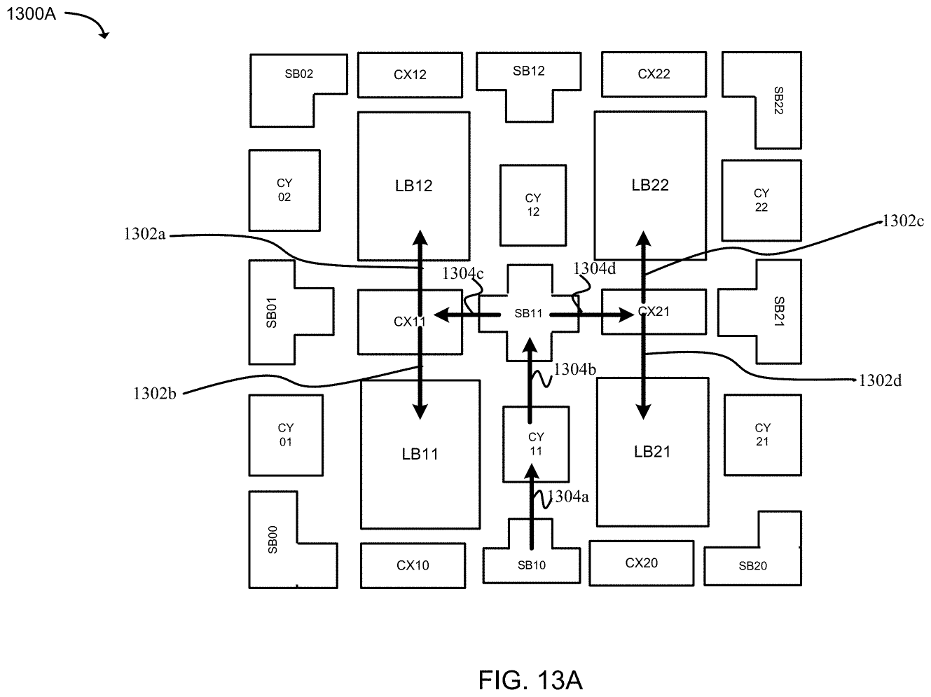

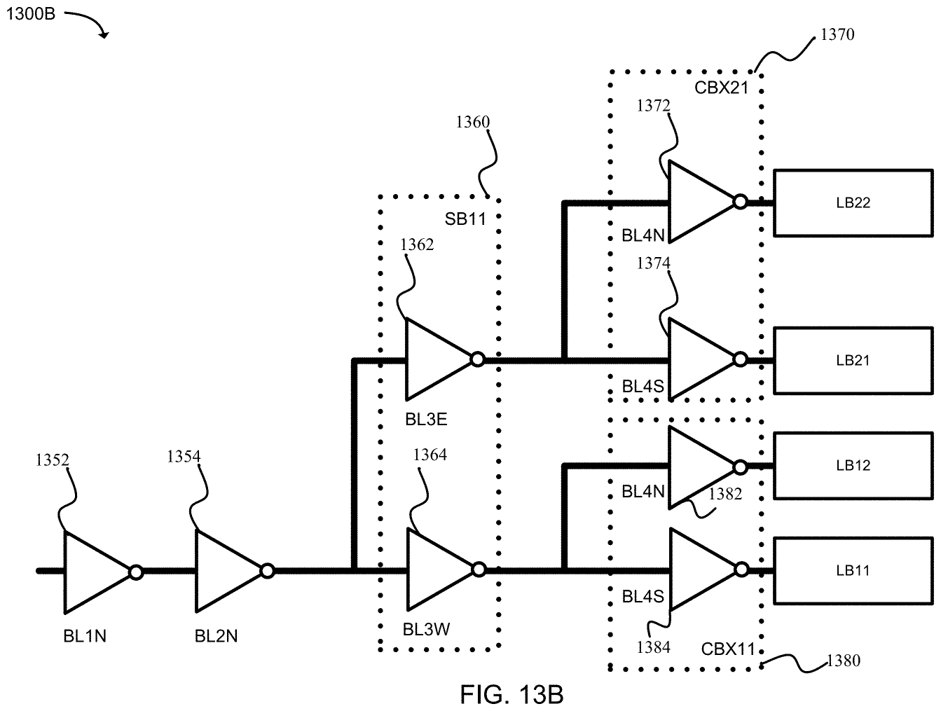

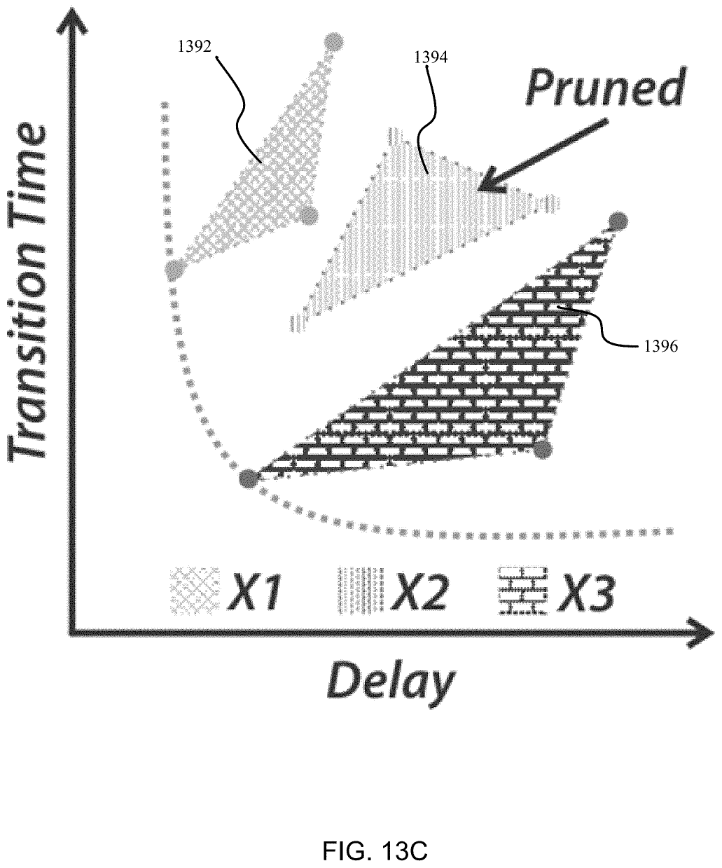

In another example, as illustrated in FIGS. 13A and 13B, a buffer size for the directional buffer can be selected using a buffer insertion operation, solution pruning, or a combination thereof. When pre-routing the clock signal, the selection of directional buffer can be based on the Pre-P&R synthesis and estimated wire length. Post-top-level P&R, the parasitic on the clock nets can vary significantly and degrade the performance. To reduce clock network latency, a size for the buffers in the clock tree was selected using the Van-Ginneken buffer insertion operation with a solution pruning policy.

In one example, the pre-routed clock network for a 2×2 FPGA 1300A is illustrated. The signal can be directed through each instance (e.g., each logic block, connection block, or switching block) and can be buffered as illustrated in FIG. 13B. In one example, the H-Tree structure can provide a path from a clock source to a clock sink. In this example, the clock signal source can be directed from SB10, to CY11 (e.g., 1304a), to SB11 (e.g., 1304b), or a combination thereof. In another example, the clock signal source can be directed from SB11, to CX11 (e.g., 1304c), to LB12 (e.g., 1302b), or a combination thereof. In another example, the clock signal source can be directed from SB11, to CX11 (e.g., 1304c), to LB11 (e.g., 1302a), or a combination thereof. In another example, the clock signal source can be directed from SB11, to CX21 (e.g., 1304d), to LB22 (e.g., 1302c), or a combination thereof. In another example, the clock signal source can be directed from SB11, to CX21 (e.g., 1304d), to LB21 (e.g., 1302d), or a combination thereof.

In one example, the signal path can pass through the same number of buffers and wire-length to limit the global skew. In one example, a signal path can include at least one of: BL1N 1352; BL2N 1354; BL3E 1362 and BL3W 1364 in SB11 1360; BL4N 1372 and BL4S 1374 in CBX21 1370; and BL4N 1382 and BL4S 1384 in CBX11 1380. In one example, BL4N 1372 can be coupled to LB22. In another example, BL4S 1374 can be coupled to LB21. In another example, BL4N 1382 can be coupled to LB12. In another example, BL4S 1384 can be coupled to LB11.

In another example, a path with an overall average latency can be selected. FIG. 13B illustrates an example of a signal path through the clock network 1300B in which BL1_N 1352, BL2_N 1354, BL3_W 1364, and BL4_N 1382 are the possible buffer placement locations. A set of 10 buffers and 10 inverters were selected as candidates for buffer placement.

An example of buffer sizing is provided. For purposes of illustration in FIG. 13C, there can be three valid buffer cells X1 1392, X2 1394, and X3 1396 for placement. The possible solutions can be enumerated by starting from the clock source node and identifying the combinations of buffers for locations BL1_N and BL2_N. A static timer analyzer (STA) engine can be used to compute the delay and skew at the output of the BL1_N, as shown in Table 1.

TABLE 1
Rendered Solutions

| BL1_N | BL2_S | Delay | Skew |
|---|---|---|---|
| X1 | X1 | 581.7 | 30.78 |
| X2 | X2 | 623.5 | 32.83 |
| X1 | X3 | 633.5 | 34.99 |
| X2 | X1 | 525.6 | 27.57 |
| X2 | X2 | 540.3 | 29.84 |
| X2 | X3 | 560.1 | 31.28 |
| X3 | X1 | 510.2 | 26.18 |
| X3 | X2 | 514.3 | 27.56 |
| X3 | X3 | 520.2 | 29.45 |

The solutions can be compared and any buffer selection at location BL1_N, that does not provide a Pareto optimal solution is dropped (or pruned), as shown in FIG. 13C. The operation can be repeated between the locations BL2_N and BL3_W until the sink node is reached. The operation can be used to select the lowest latency solution.

In another example, before buffer selection, the clock tree from the source node to each sink node can be extracted from the module post-P&R netlist with the respective parasitic and cell loads on the nets. This operation can reduce the timing computation runtime of an STA engine which is executed iteratively in the operation.

Therefore, runtime reduced hierarchical flow can include modifying the netlist to pre-route the global and clock signal by using the design planning information from a smaller design (replica architecture). The FPGA modules can be placed and routed and merged at the top level. The top-level P&R stage can skip placement and clock tree synthesis because these global signals can be pre-routed. The FPGA design can be enhanced using a post-module P&R buffer sizing selection.

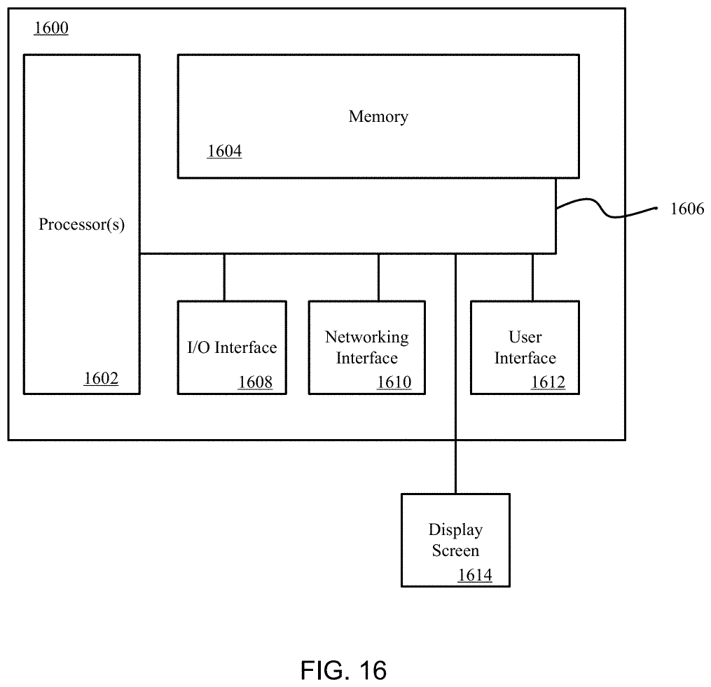

FIG. 16 illustrates a general computing system or device 1600 that can be employed in the present technology. The computing system 1600 can include a processor 1602 in communication with a memory 1604. The memory 1604 can include any device, combination of devices, circuitry, and the like that is capable of storing, accessing, organizing, and/or retrieving data. Non-limiting examples include SANs (Storage Area Network), cloud storage networks, volatile or non-volatile RAM, phase change memory, optical media, hard-drive type media, and the like, including combinations thereof.

The computing system or device 1600 additionally includes a local communication interface 1606 for connectivity between the various components of the system. For example, the local communication interface 1606 can be a local data bus and/or any related address or control busses as may be desired.

The computing system or device 1600 can also include an I/O (input/output) interface 1608 for controlling the I/O functions of the system, as well as for I/O connectivity to devices outside of the computing system 1600. A network interface 1610 can also be included for network connectivity. The network interface 1610 can control network communications both within the system and outside of the system. The network interface can include a wired interface, a wireless interface, a Bluetooth interface, optical interface, and the like, including appropriate combinations thereof. Furthermore, the computing system 1600 can additionally include a user interface 1612, a display device 1614, as well as various other components that would be beneficial for such a system.

The processor 1602 can be a single or multiple processors, and the memory 1604 can be a single or multiple memories. The local communication interface 1606 can be used as a pathway to facilitate communication between any of a single processor, multiple processors, a single memory, multiple memories, the various interfaces, and the like, in any useful combination.

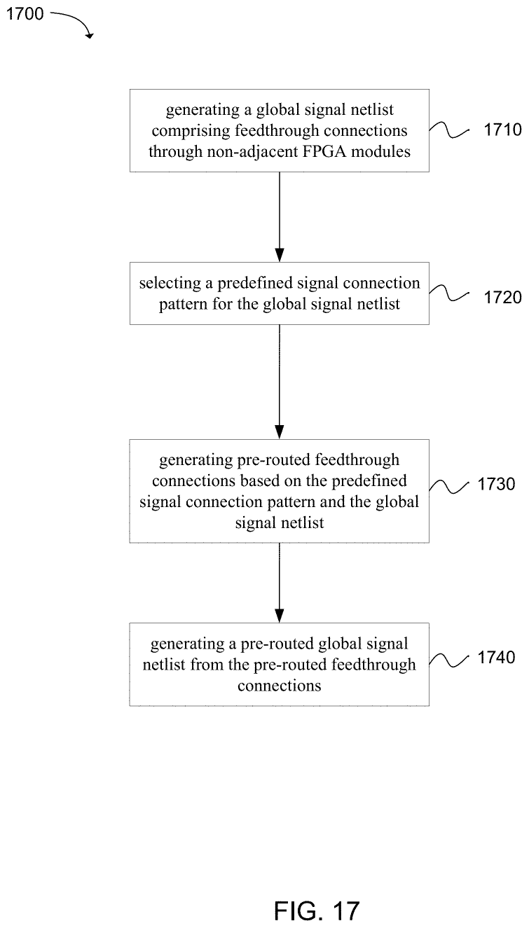

FIG. 17 illustrates a flow diagram of a method according to the present technology. For simplicity of explanation, the method is depicted and described as a series of acts. However, acts in accordance with this disclosure can occur in various orders and/or concurrently, and with other acts not presented and described herein. Furthermore, not all illustrated acts may be used to implement the methods in accordance with the disclosed subject matter.

In one embodiment, a method 1700 for reducing a top-level placement and routing (P&R) runtime of a field programmable gate array (FPGA) can comprise generating a global signal netlist comprising feedthrough connections through non-adjacent FPGA modules, as shown in block 1710. In one aspect, the method can comprise selecting a predefined signal connection pattern for the global signal netlist, as shown in block 1720. In another aspect, the method can comprise generating pre-routed feedthrough connections based on the predefined signal connection pattern and the global signal netlist, as shown in block 1730. In another aspect, the method can comprise generating a pre-routed global signal netlist from the pre-routed feedthrough connections, as shown in block 1740.

In one aspect, the method 1700 can comprise providing a multiple-directional routing structure for at least one FPGA module. In another aspect, the method 1700 can comprise selecting a directional buffer between an IN pin and OUT pin for at least one FPGA module. In another aspect, the method 1700 can comprise selecting the directional buffer based on estimated wire load from pre-routing synthesis. In another aspect, the method 1700 can comprise selecting a buffer size for the directional buffer using a buffer insertion operation and solution pruning. In another aspect, the method 1700 can comprise increasing routing track spacing to align the routing tracks to a selected multiple of a contracted poly pitch (CPP) distance. In another aspect, the method 1700 can comprise maintaining a selected channel size between adjacent FPGA modules to facilitate buffer insertion. In another aspect, the method 1700 can comprise adjusting at least one of a pitch and a width of a strap to metal tracks.

In another aspect, the method 1700 can comprise estimating an arrival time at an FPGA module boundary of an FPGA module without using top-level placement and routing. In another aspect, the method 1700 can comprise placing the FPGA module without using top-level placement and routing. In another aspect, the method 1700 can comprise synthesizing a clock tree at the FPGA module without using top-level placement and routing. In another aspect, the method 1700 can comprise routing the FPGA module without using top-level placement and routing. In another aspect, the method 1700 can comprise inserting filler cells at the FPGA module without using top-level placement and routing

Also provided is at least one machine readable storage medium having instructions embodied thereon for reducing a top-level placement and routing (P&R) runtime of a field programmable gate array (FPGA). The instructions can be executed on a machine, where the instructions are included on at least one computer readable medium or one non-transitory machine-readable storage medium. The instructions when executed can perform generating a global signal netlist comprising feedthrough connections through non-adjacent FPGA modules. The instructions when executed can perform selecting a predefined signal connection pattern for the global signal netlist. The instructions when executed can perform generating pre-routed feedthrough connections based on the predefined signal connection pattern and the global signal netlist. The instructions when executed can perform generating a pre-routed global signal netlist from the pre-routed feedthrough connections.

While the flowcharts presented for this technology may imply a specific order of execution, the order of execution may differ from what is illustrated. For example, the order of two more blocks may be rearranged relative to the order shown. Further, two or more blocks shown in succession may be executed in parallel or with partial parallelization. In some configurations, one or more blocks shown in the flow chart may be omitted or skipped. Any number of counters, state variables, warning semaphores, or messages might be added to the logical flow for purposes of enhanced utility, accounting, performance, measurement, troubleshooting or for similar reasons.

Various techniques, or certain aspects or portions thereof, can take the form of program code (i.e., instructions) embodied in tangible media, such as floppy diskettes, compact disc-read-only memory (CD-ROMs), hard drives, non-transitory computer readable storage medium, or any other machine-readable storage medium wherein, when the program code is loaded into and executed by a machine, such as a computer, the machine becomes an apparatus for practicing the various techniques. Circuitry can include hardware, firmware, program code, executable code, computer instructions, and/or software. A non-transitory computer readable storage medium can be a computer readable storage medium that does not include signal. In the case of program code execution on programmable computers, the computing device can include a processor, a storage medium readable by the processor (including volatile and non-volatile memory and/or storage elements), at least one input device, and at least one output device. The volatile and non-volatile memory and/or storage elements can be a random-access memory (RAM), erasable programmable read only memory (EPROM), flash drive, optical drive, magnetic hard drive, solid state drive, or other medium for storing electronic data. The low energy fixed location node, wireless device, and location server can also include a transceiver module (i.e., transceiver), a counter module (i.e., counter), a processing module (i.e., processor), and/or a clock module (i.e., clock) or timer module (i.e., timer). One or more programs that can implement or utilize the various techniques described herein can use an application programming interface (API), reusable controls, and the like. Such programs can be implemented in a high-level procedural or object-oriented programming language to communicate with a computer system. However, the program(s) can be implemented in assembly or machine language, if desired. In any case, the language can be a compiled or interpreted language, and combined with hardware implementations.

As used herein, the term processor can include general purpose processors, specialized processors such as VLSI, FPGAs, or other types of specialized processors, as well as base band processors used in transceivers to send, receive, and process wireless communications.

It should be understood that many of the functional units described in this specification have been labeled as modules, in order to more particularly emphasize their implementation independence. For example, a module can be implemented as a hardware circuit comprising custom very-large-scale integration (VLSI) circuits or gate arrays, off-the-shelf semiconductors such as logic chips, transistors, or other discrete components. A module can also be implemented in programmable hardware devices such as field programmable gate arrays, programmable array logic, programmable logic devices or the like.

In one example, multiple hardware circuits or multiple processors can be used to implement the functional units described in this specification. For example, a first hardware circuit or a first processor can be used to perform processing operations and a second hardware circuit or a second processor (e.g., a transceiver or a baseband processor) can be used to communicate with other entities. The first hardware circuit and the second hardware circuit can be incorporated into a single hardware circuit, or alternatively, the first hardware circuit and the second hardware circuit can be separate hardware circuits.

Modules can also be implemented in software for execution by various types of processors. An identified module of executable code can, for instance, comprise one or more physical or logical blocks of computer instructions, which can, for instance, be organized as an object, procedure, or function. Nevertheless, the executables of an identified module need not be physically located together but can comprise disparate instructions stored in different locations which, when joined logically together, comprise the module and achieve the stated purpose for the module.

Indeed, a module of executable code can be a single instruction, or many instructions, and can even be distributed over several different code segments, among different programs, and across several memory devices. Similarly, operational data can be identified and illustrated herein within modules and can be embodied in any suitable form and organized within any suitable type of data structure. The operational data can be collected as a single data set or can be distributed over different locations including over different storage devices, and can exist, at least partially, merely as electronic signals on a system or network. The modules can be passive or active, including agents operable to perform desired functions.

The following examples are provided to promote a clearer understanding of certain embodiments of the present disclosure and are in no way meant as a limitation thereon.

### EXAMPLE 1

### Runtime Comparison for Hierarchical Design Flow

The runtime is provided in the chart 800 in FIG. 8 for: (1) a 2×2 FPGA having 40 LUTs, (2) a 4×4 FPGA having 160 LUTs, (3) an 8×8 FPGA having 640 LUTs, and a 16×16 FPGA having 2560 LUTs. For this experiment, the top-level P&R flow started with linking child FPGA modules and defining global signal constraints, followed by global placement and clock tree synthesis operations. The placement operation resolved all high fanout nets based on user-defined constraints and adds buffers in the top-level netlist. Clock tree synthesis connected the input clock net to the FPGA module's input based on the minimum global skew and latency targets. The routing operation resulted in a significantly low runtime as many nets had a straight connection on the same layer.

As shown in FIG. 8, for the 2×2 FPGA having 40 LUTs, the total runtime for the design planning stage, the module P&R stage, and the top-level integration stage was about 3 hours. The design planning stage had a duration of about 1.5 hours, the module P&R stage had a duration of about 0.5 hours, and the top-level integration stage has a duration of about 1 hour. Consequently, the total runtime for the 2×2 FPGA was constrained by all three stages.

For the 4×4 FPGA having 160 LUTs, the total runtime for the design planning stage, the module P&R stage, and the top-level integration stage was about 7.3 hours. The design planning stage had a duration of about 3 hours, the module P&R stage had a duration of about 0.5 hours, and the top-level integration stage has a duration of about 3.8 hours. Consequently, the total runtime for the 4×4 FPGA was constrained by the top-level integration stage more than the design planning stage or the module P&R stage.

For the 8×8 FPGA having 640 LUTs, the total runtime for the design planning stage, the module P&R stage, and the top-level integration stage was about 16 hours. The design planning stage had a duration of about 6 hours, the module P&R stage had a duration of about 0.5 hours, and the top-level integration stage has a duration of about 9.5 hours. Consequently, the total runtime for the 8×8 FPGA was constrained by the top-level integration stage and the design planning stage more than the module P&R stage.

For the 16×16 FPGA having 2560 LUTs, the total runtime for the design planning stage, the module P&R stage, and the top-level integration stage was greater than 24 hours. The design planning stage had a duration of about 20 hours, the module P&R stage had a duration of about 0.5 hours, and the top-level integration stage has a duration that had exponentially increased when compared to the comparable stage for the 2×2 FPGA, the 4×4 FPGA, or the 8×8 FPGA. Consequently, the total runtime for the 2×2 FPGA was constrained by the top-level integration stage and the design planning stage more than the module P&R stage.

### EXAMPLE 2

### Overview of Experimental Study on Runtime Reduced Hierarchical Flow

The architecture parameters for conducting an experimental study on runtime reduced hierarchical flow are summarized in Table 2.

TABLE 2
Architecture Parameters

| Architecture Parameters | Value |
|---|---|
| LUT Inputs | 6 |
| LE/Logic Blocks | 10 |
| Crossbar connectivity | 50% |
| Fcᵢₙ | 0.055 |
| Fcₒᵤₜ | 0.1 |

The architecture resembled the Stratix-IV FPGA which is a modern architecture used for FPGA-related experimental studies. Each logic block was designed with a 10-configuration chain programming protocol to configure the FPGA, and an integrated scan-chain to enable functional testing. The experiment resulted in the generation of the physical design for an FPGA with more than 100k LUTs within 24-hours of runtime. To evaluate scalability, a design was implemented ranging from a 2×2 FPGA having 40 LUTs to a 128×128 FPGA having 164 k LUTs. The OpenFPGA framework was used to generate the technology mapped Verilog netlists without an explicit synthesis run.

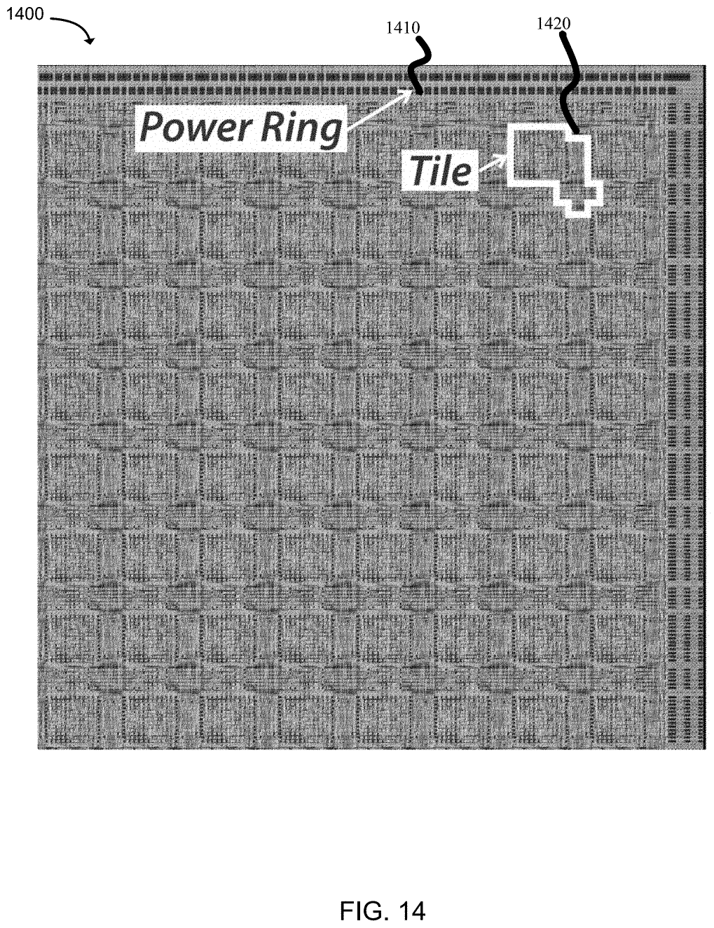

FIG. 14 provides a GDS view of a 128×128 FPGA. For better discernibility, the top-right corner 8×8 grid 1400 of the 128×128 FPGA is shown. The layout has a repetitive structure and includes a power ring 1410 and a tile (e.g., an FPGA module) 1420.

Synopsys IC Compiler II was used for placement and routing and Synopsys PrimeTime was used for timing analysis. The commercial Stratix-IV device was fabricated in a TSMC 40 nm process with a standard cell library. Although the experiment did not use any custom cells, the approach can be entirely scalable with the addition of custom cells; therefore, any achievable area and delay benefits can be used with this runtime reduced hierarchical flow approach. Similarly, the runtime reduced hierarchical flow approach can be extended to heterogeneous architecture by swapping a few FPGA tiles or FPGA modules with hard IP blocks (e.g., memory, multiplier, fast adder).

### EXAMPLE 3

### Runtime Comparison Between Runtime Reduced Hierarchical Flow and Hierarchical Design Flow

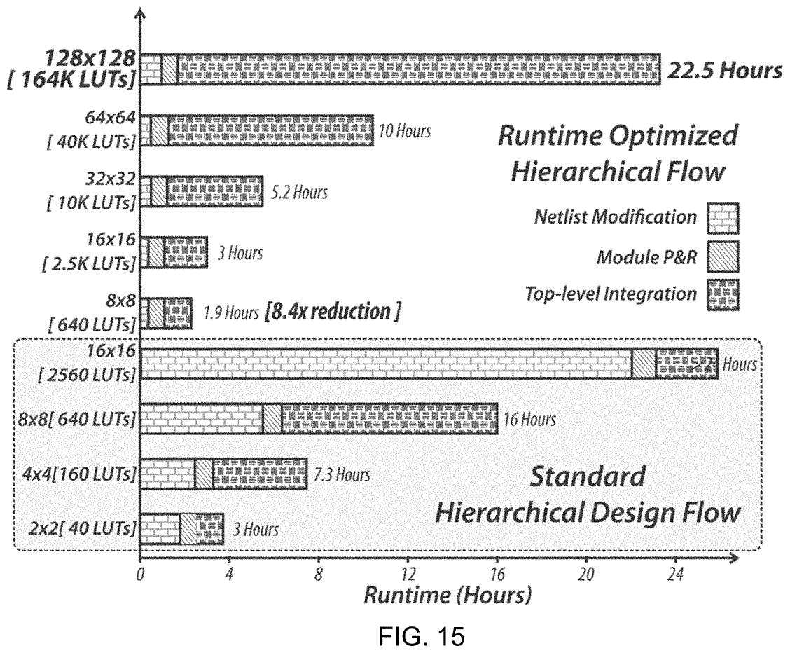

The significant reduction in the P&R runtime is shown in FIG. 15, which validates the runtime reduced hierarchical flow methodology for designing an FPGA with 100 k LUTs within 24-hours.

For the comparative study, the 8×8 FPGA using the Hierarchical Design flow process had a runtime of about 16 hours, whereas with the runtime reduced hierarchical flow methodology, the runtime was reduced to about 1.9 hours—a reduction of about 8.4×. In addition, a similar architecture in 65 nm technology for a 20×20 FPGA had a runtime of about 24-hours, but the runtime reduced hierarchical flow methodology had a total runtime that was about 8× less for a comparatively similar 16×16 FPGA.

As shown in FIG. 15, for the 8×8 FPGA having 6450 LUTs, the total runtime for the netlist modification stage, the module P&R stage, and the top-level integration stage was about 1.9 hours. The netlist modification stage had a duration of about 0.2 hours, the module P&R stage had a duration of about 0.5 hours, and the top-level integration stage has a duration of about 1.2 hours. Consequently, the total runtime for the 8×8 FPGA was constrained by all three stages.

For the 16×16 FPGA having about 2.5 k LUTs, the total runtime for the netlist modification stage, the module P&R stage, and the top-level integration stage was about 3 hours. The netlist modification stage had a duration of about 0.2 hours, the module P&R stage had a duration of about 0.5 hours, and the top-level integration stage had a duration of about 2.3 hours. Consequently, the total runtime for the 16×16 FPGA was constrained by the top-level integration stage more than the module P&R stage or the netlist modification stage.

For the 32×32 FPGA having about 10 k LUTs, the total runtime for the netlist modification stage, the module P&R stage, and the top-level integration stage was about 5.2 hours. The netlist modification stage had a duration of about 0.2 hours, the module P&R stage had a duration of about 0.5 hours, and the top-level integration stage had a duration of about 4.5 hours. Consequently, the total runtime for the 32×32 FPGA was constrained by the top-level integration stage more than the module P&R stage or the netlist modification stage.

For the 64×64 FPGA having about 40 k LUTs, the total runtime for the netlist modification stage, the module P&R stage, and the top-level integration stage was about 22.5 hours. The netlist modification stage had a duration of about 1 hour, the module P&R stage had a duration of about 0.5 hours, and the top-level integration stage had a duration of about 21 hours. Consequently, the total runtime for the 64×64 FPGA was constrained by the top-level integration stage more than the module P&R stage or the netlist modification stage.

The runtime results in FIG. 15 also showed an approximately linear runtime increase with higher number of LUTs which allows a better estimation of runtime for different sizes of FPGA.

### EXAMPLE 4

### Clock Skew and Latency Comparison Between Runtime Reduced Hierarchical Flow and Hierarchical Design Flow

Table 3 depicts the clock latency obtained for each FPGA design to show the performance enhancement resulting from the buffer sizing technique. The longest wire length was also measured in the pre-routed H-tree clock network. The latency observed was linearly proportional to the wire length which allowed for better estimation when scaling up the design. Designing a custom layout for each size of FPGA design was infeasible; hence, the hierarchical design flow was compared with the runtime reduced hierarchical flow design. In the hierarchical design flow, the clock tree was synthesized by the automated P&R tool with maximum effort to reduce clock skew and latency to provide a suitable benchmark for the work.

TABLE 3
Clock Network Latency and Skew Comparison

| | Hierarchical Design | | Runtime Reduced Hierarchical | | |
|---|---|---|---|---|---|
| | Flow | | Flow | | |
| | Latency | Skew | Latency | Skew | Length |
| Size | A (ps) | A (ps) | B (ps) | B (ps) | (μm) |
| 2 × 2 | 122.52 | 30.6 | 134 | 10.11 | 95.08 |
| 4 × 4 | 252.56 | 50.4 | 304 | 12.45 | 380.32 |
| 8 × 8 | 380.4 | 70.4 | 437 | 15.4 | 950.8 |
| 16 × 16 | | | 2658 | 19.87 | 2091.76 |
| 32 × 32 | | | 4566 | 32.2 | 4373.68 |
| 64 × 64 | | | 8954 | 50.5 | 8937.52 |
| 128 × 128 | | | 21012 | 70.56 | 18065.2 |

Table 2 shows various results for the FPGAs of various sizes for the hierarchical design flow methodology and the runtime reduced hierarchical flow methodology. For a 2×2 FPGA, there was an increase in latency from 122.52 ps to 134 ps but about a 3× reduction in skew from 30.6 ps to 10.11 ps. For a 4×4 FPGA, there was an increase in latency from 252.56 ps to 304 ps but about a 5× reduction in skew from 50.4 ps to 12.45 ps. For an 8×8 FPGA, there was a 15% increase in the clock latency (from about 380.4 ps to about 437 ps) but a 4× reduction in skew (from about 70.4 ps to about 15.4 ps).

Table 2 also shows further results for FPGAs of increased sizes. For a 16×16 FPGA, the latency was about 2658 ps with a skew of about 19.87 ps and a length of about 2091 μm. For a 32×32 FPGA, the latency was about 4566 ps with a skew of about 32.2 ps and a length of about 4373.68 μm. For a 64×64 FPGA, the latency was about 89548 ps with a skew of about 50.5 ps and a length of about 8937.52 μm. For a 128×128 FPGA, the latency was about 21012 ps with a skew of about 70.56 ps and a length of about 18065.2 μm.

### EXAMPLE 5

### Summary of Experimental Results

A scalable and robust hierarchical floor-planning technique to design a 100 k LUTs FPGA was provided. The design showed that a runtime of fewer than 24-hours was achievable. ASIC toolchains were combined with hierarchical flow to perform floor-planning on small-size FPGA architecture and applied to for larger FPGA floor-planning. To reduce the runtime, feedthrough creation was used to bypass time-consuming top-level integration, i.e., clock tree synthesis. The proposed post-P&R sizing strategy allowed latency reduction of pre-routed global signals. The achieved 24-hour prototyping allowed the rapid development of the FPGA fabric.

Reference throughout this specification to “an example” means that a particular feature, structure, or characteristic described in connection with the example is included in at least one embodiment of the present invention. Thus, appearances of the phrases “in an example” in various places throughout this specification are not necessarily all referring to the same embodiment.

Reference was made to the examples illustrated in the drawings and specific language was used herein to describe the same. It will nevertheless be understood that no limitation of the scope of the technology is thereby intended. Alterations and further modifications of the features illustrated herein and additional applications of the examples as illustrated herein are to be considered within the scope of the description.

Furthermore, the described features, structures, or characteristics may be combined in any suitable manner in one or more examples. In the preceding description, numerous specific details were provided, such as examples of various configurations to provide a thorough understanding of examples of the described technology. It will be recognized, however, that the technology may be practiced without one or more of the specific details, or with other methods, components, devices, etc. In other instances, well-known structures or operations are not shown or described in detail to avoid obscuring aspects of the technology.

Although the subject matter has been described in language specific to structural features and/or operations, it is to be understood that the subject matter defined in the appended claims is not necessarily limited to the specific features and operations described above. Rather, the specific features and acts described above are disclosed as example forms of implementing the claims. Numerous modifications and alternative arrangements may be devised without departing from the spirit and scope of the described technology.

The foregoing detailed description describes the invention with reference to specific exemplary embodiments. However, it will be appreciated that various modifications and changes can be made without departing from the scope of the present invention as set forth in the appended claims. The detailed description and accompanying drawings are to be regarded as merely illustrative, rather than as restrictive, and all such modifications or changes, if any, are intended to fall within the scope of the present invention as described and set forth herein.

What is claimed is:

1. A method for rapid prototyping of a field programmable gate array (FPGA), comprising:
generating a global signal netlist of global signals comprising feedthrough connections through non-adjacent FPGA modules;
selecting a predefined signal connection pattern for the global signals;
generating pre-routed feedthrough connections based on the predefined signal connection pattern and the global signal netlist; and
generating a pre-routed global signal netlist from the pre-routed feedthrough connections.

2. The method of claim 1, further comprising:
providing a multiple-directional routing structure for at least one FPGA module.

3. The method of claim 1, further comprising:
selecting a directional buffer between an IN pin and OUT pin for at least one FPGA module.

4. The method of claim 3, further comprising:
selecting the directional buffer based on estimated wire load from pre-routing synthesis.

5. The method of claim 4, further comprising:
selecting a buffer size for the directional buffer using a buffer insertion operation and solution pruning.

6. The method of claim 1, wherein the global signal netlist comprises a reset signal, a flip-flop chain signal, a clock net signal, or a combination thereof.

7. The method of claim 5, wherein the global signal netlist is a clock net signal.

8. The method of claim 6, wherein the predefined signal connection pattern is an H-tree structure.

9. The method of claim 8, wherein the H-tree structure includes one or more nested H-trees.

10. The method of claim 1, further comprising:
increasing routing track spacing to align routing tracks to a selected multiple of a contacted poly pitch (CPP) distance.

11. The method of claim 1, further comprising:
maintaining a selected channel size between adjacent FPGA modules to facilitate buffer insertion.

12. The method of claim 1, further comprising:
adjusting at least one of a pitch and a width of a strap to metal tracks.

13. The method of claim 1, further comprising:
estimating an arrival time at an FPGA module boundary of an FPGA module without using top-level placement and routing; or
placing an FPGA module without using top-level placement and routing; or
synthesizing a clock tree at the FPGA module without using top-level placement and routing; or
routing the FPGA module without using top-level placement and routing; or
inserting filler cells at the FPGA module without using top-level placement and routing.

14. A field-programmable gate array (FPGA) module comprising:
an input pin, a multiple-directional routing structure, and an output pin, wherein:
the input pin is configured to: receive a pre-routed global signal from a pre-routed global signal source, and send the pre-routed global signal to the multiple-directional routing structure;
the multiple-directional routing structure is configured to send the pre-routed global signal to the output pin; and
the output pin is configured to send the pre-routed global signal through a pre-routed feedthrough connection to a non-adjacent FPGA module.

15. The FPGA module of claim 14, further comprising:
a directional buffer between the input pin and output pin, wherein the directional buffer is selected based on estimated wire load from pre-routing synthesis.

16. The FPGA module of claim 15, wherein a buffer size for the directional buffer is selected using a buffer insertion operation and solution pruning.

17. The FPGA module of claim 14, wherein the pre-routed global signal comprises a reset signal, a flip-flop chain signal, a clock net signal, or a combination thereof.

18. The FPGA module of claim 14, wherein the pre-routed global signal is a clock net signal.

19. A field-programmable gate array (FPGA), comprising:
an FPGA module configured to send a pre-routed global signal to a non-adjacent FPGA module through a pre-routed feedthrough connection identified using a predefined signal connection pattern.

20. The FPGA of claim 19, wherein the pre-routed global signal comprises a reset signal, a flip-flop chain signal, a clock net signal, or a combination thereof.

21. The FPGA of claim 19, wherein the predefined signal connection pattern is an H-tree structure.

22. The FPGA of claim 21, wherein the H-tree structure includes one or more nested H-trees.

23. The FPGA of claim 19, further comprising:
routing track spacing selected to align routing tracks to a selected multiple of a contacted poly pitch (CPP) distance.

24. The FPGA of claim 19, further comprising:
a channel size between adjacent FPGA modules that is selected to facilitate buffer insertion.

25. The FPGA of claim 19, wherein at least one of a pitch and a width of a strap is adjusted to metal tracks.
